(19) United States
(12) Patent Application Publication
(10) Pub. No.: US 2023/0224061 A1
(43) Pub. Date: Jul. 13, 2023

(54) SYSTEMS AND METHODS FOR NETWORK ELEMENT NEIGHBOR DISCOVERY

(71) Applicant: Infinera Corp., San Jose, CA (US)

(72) Inventors: Ashok Kunjidhapatham, Devarachikkanahalli (IN); Ashwini Kumar Bhat, Bangalore (IN); G. J. Raghavendra, Bangalore (IN); Abhilasha Subraya Hegde, Bangalore (IN)

(21) Appl. No.: 18/152,440

(22) Filed: Jan. 10, 2023

Related U.S. Application Data
(60) Provisional application No. 63/298,183, filed on Jan. 10, 2022.

(51) Int. Cl. H04J 14/02

(52) U.S. Cl. CPC H04J 14/0212; H04J 14/0217

(57) ABSTRACT

Disclosed herein are systems and methods for neighbor discovery for any network transport layer; including a network element comprising: a processor, an interface connected to a network having a control channel, and instructions that, when executed by the processor, cause the network element to: generate a discover message comprising a message identification, a discovered node ID, and a discovered interface ID; send a first signal comprising the discover message over the control channel to a second network element; and receive a second signal comprising an acknowledgment message from the second network element over the control channel, the acknowledgment message being one of a positive acknowledgment message and a negative acknowledgment message; and wherein receipt of the positive acknowledgment message indicates that contents of the discover message were matched by the second network element, and receipt of the negative acknowledgment indicates that there was at least one mismatch in the contents.

### CROSS REFERENCE TO RELATED APPLICATION

This application claims the benefit of U.S. Provisional Patent Application No. 63/298,183, titled “Simple Neighbor Discovery Protocol”, which was filed on Jan. 10, 2022, the contents of which are incorporated herein by reference in their entirety.

### BACKGROUND

For computer network systems to function, network elements often need to discover (that is, determine) the neighboring network element(s) and their port(s) associated with the neighboring network element(s). The network elements may exchange information regarding the capabilities (such as interface capabilities and/or node capabilities) of the network elements and the ports, such that the network elements (for example, a network element at each “end” of a network) are aware of each other's capabilities at any given point in time. It may be important to the function of the network to have continuous, repetitive, and/or consistent monitoring of the connectivity between network elements and to detect changes in the network elements' neighbor associations. This discovery and exchange may be ruled by one or more network protocols, such as control plane protocols. Generally, data network protocols are sets of rules that govern how data is transmitted between network elements.

Currently, exemplary discovery network protocols include Link Layer Discovery Protocol (LLDP) and Link Management Protocol (LMP). LLDP was defined by IEEE to address discovery requirements on ethernet based networks (for example, as described in IEEE 802.1AB (2016)). More often, LLDP is used in conjunction with software-defined networking (SDN) controllers to enable discovery of network topologies. There are no standards defined for the adaption of LLDP for the neighbor discovery in layers other than Layer1 (Ethernet). Proprietary extensions are required to make LLDP work for Layer0 and Layer1 networks. LMP and OSPF Link Local LSA (link-state advertisement) (from IETF) are other mechanisms used for link discovery in GMPLS networks, but discovery is only a portion of the complex mechanisms of those protocols, which is unwieldly. Further, ITU-T G.7714.1, “Protocol for automatic discovery in transport networks” (Edition 4.0, 08/13/2017) extends Trail Trace Identifier (TTI) mechanisms for use for discovery, but TTI is not always used for the Optical Layer.

However, discovery functionality provided by these protocols cannot be easily adapted for generic application in all transport layers because each of these protocols have been defined for a specific transport layer(s) to address a specific set of requirements. Further, these protocols have inherent assumptions on how protocol data units (PDUs) are encapsulated and exchanged on a network. Additionally, existing protocols do not determine capabilities of neighboring network elements for multiple transport layers.

A protocol to provide discovery and other network functionality, beyond discovery, that can be used in all transport layers is needed. Additionally, a protocol is needed that is aware of a scope of a Layer 0 link (e.g., whether a link is an optical multiplex section or an optical transmission section) and that allows the neighbor discovery for multiple data ports sharing a common control channel, for example, for use in some Layer1 (OTN) networks.

### SUMMARY

The methods and systems disclosed herein solve the above and other problems by providing a generic, layer-independent neighbor discovery protocol (referred to herein as a Simple Neighbor Discovery Protocol (SNDP)) that can be used for network element neighbor discovery for any transport layer (Layer0 to Layer3). The flexibility in the protocol data unit (PDU) transport mechanism allows easy adoption into any messaging protocol (PPP/HDLC, Ethernet, or IP) supported by a control channel. Further, SNDP allows the neighbor discovery for multiple interfaces sharing a common control channel, such as in Layer1 (OTN) networks, which is not possible in known link discovery mechanisms.

In one aspect, in accordance with some implementations, the specification describes methods and systems including a network, comprising: a first network element having a first processor, a first non-transitory computer readable memory storing first instructions, and a first network interface; a second network element having a second processor, a second non-transitory computer readable memory storing second instructions, and a second network interface; and a network transmission section connecting the first network element and the second network element; wherein the first instructions, when executed by the first processor, cause the first processor to generate a discover message and send the discover message from the first network interface over the network transmission section to the second network element, the discover message comprising a message identification, a discovered node ID, and a discovered interface ID; wherein after receiving the discover message, the second instructions, when executed by the second processor, cause the second processor to generate an acknowledgment message, the acknowledgment message being one of a positive acknowledgment message and a negative acknowledgment message, the positive acknowledgment message indicating that the discovered node ID and the discovered interface ID in the discover message match data identifying the second network element, and the negative acknowledgment message indicating that there was at least one mismatch to the data identifying the discovered node ID and the discovered interface ID in the discover message received by the second network element; and wherein the second instructions, when executed by the second processor, cause the second processor to send the acknowledgment message from the second network interface over the network transmission section to the first network element.

In some implementations of the exemplary network, the network transmission section may further comprise a control channel, and the discover message and the acknowledgment message may be sent over the control channel.

In some implementations of the exemplary network, the network transmission section may be an optical transmission section, the discover message may be a first discover message, and the acknowledgment message may be a first acknowledgment message, and the first network element may further comprises a first logical interface and a second logical interface and the second network element further comprises a third logical interface and a fourth logical interface, the first logical interface and the third logical interface associated with an optical multiplex section of the network formed between the first network element and the second network element, and the second logical interface and the fourth logical interface associated with the optical transmission section; wherein the first discovery message and the second discovery message are sent over the control channel on behalf of the second logical interface and the fourth logical interface; and wherein the first instructions, when executed by the first processor, cause the first processor to generate a second discover message and send the second discover message from the first network interface over the control channel on behalf of the first logical interface to the third logical interface of the second network element, the second discover message comprising a message identification, a discovered node ID, and a discovered interface ID; wherein after receiving the second discover message, the second instructions, when executed by the second processor, cause the second processor to generate a second acknowledgment message, the second acknowledgment message being one of a positive acknowledgment message and a negative acknowledgment message, wherein the positive acknowledgment message indicating that the discovered node ID and the discovered interface ID in the second discover message were matched to identifying data of the second network element, and the negative acknowledgment indicating that there was at least one mismatch to the identifying data of the discovered node ID and the discovered interface ID in the second discover message received by the second network element; and wherein the second instructions, when executed by the second processor, cause the second processor to send the second acknowledgment message from the second network interface over the control channel on behalf of the third logical interface to the first logical interface of the first network element.

In some implementations of the exemplary network, the network may further comprise a second network transmission section and a third network element having a third processor, a third non-transitory computer readable memory storing third instructions, a third network interface, and a fourth network interface, the first network transmission section connecting the first network element and the third network element and the second network transmission section connecting the third network element and the second network element to form an optical multiplex section; wherein the third instructions, when executed by the third processor, cause the third processor to generate a notify message when the third network element is connected to the network, the notify message comprising a source node ID and a notification type and send the notify message from the third interface over the first network transmission section to the first network interface of the first network element; and wherein, upon receipt of the notify message, the first instructions, when executed by the first processor, cause the first processor to enter a new discovery cycle associated with the third network element.

In some implementations of the exemplary network, entering the new discovery cycle may cause the first network element to generate and send a second discover message to the third network element; and upon receiving the second discover message, the third instructions may cause the third network element to generate and send a second acknowledgment message to the first network element.

In some implementations of the exemplary network, the first instructions, when executed by the first processor, may cause the first processor to generate and send a third discover message to the second network element, the third discover message configured to be transparently forwarded by the third network element to the second network element; and upon receiving the third discover message, the second network element may generate and send a third acknowledgment message to the first network element, the third acknowledgment message configured to be transparently forwarded by the third network element to the first network element.

In some implementations of the exemplary network, the third instructions may cause the third processor to generate and send a second discover message to the second network element from the fourth network interface over the second network transmission section to the second network element, the second discover message comprising a message identification, a discovered node ID, and a discovered interface ID; wherein after receiving the second discover message, the second instructions, when executed by the second processor, cause the second processor to generate a second acknowledgment message, the second acknowledgment message being one of a positive acknowledgment message and a negative acknowledgment message, wherein the positive acknowledgment message indicating that the discovered node ID, and the discovered interface ID in the second discover message match identifying data of the second network element, and the negative acknowledgment indicating that there was at least one mismatch to the identifying data of the discovered node ID and the discovered interface ID in the second discover message received by the second network element; and wherein the second instructions, when executed by the second processor, cause the second processor to send the second acknowledgment message from the second network interface over the second optical transmission section to the third network element.

In some implementations of the exemplary network, the first instructions, when executed by the first processor, may cause the first processor to generate and send a second discover message to the second network element, the second discover message comprising a message identification, a discovered node ID, a discovered interface ID, and link topology information including nodal info of the first network element, wherein the second discover message is sent from the first interface of the first network element over the first network transmission section to the third interface of the third network element; wherein, upon receipt of the second discover message, the third instructions cause the third processor to save the link topology information from the second discover message in the third non-transitory computer readable memory and append nodal info of the third network element to the link topology information and forward the second discover message from the fourth interface to the second interface of the second network element; wherein, after receiving the second discover message, the second instructions, when executed by the second processor, cause the second processor to save the link topology information from the second discover message in the second non-transitory computer readable memory, append the link topology information with nodal information of the second network element, and generate a second acknowledgment message including the link topology information, the second acknowledgment message being one of a positive acknowledgment message and a negative acknowledgment message, the positive acknowledgment message indicating that the discovered node ID and the discovered interface ID in the second discover message match identifying data of the second network element, and the negative acknowledgment indicating that there was at least one mismatch to the identifying data of the discovered node ID and the discovered interface ID in the second discover message received by the second network element; wherein the second instructions, when executed by the second processor, cause the second processor to send the second acknowledgment message from the second network interface over the second network transmission section to the fourth network interface of the third network element; wherein, upon receiving the second acknowledgment message, the third instructions cause the third processor to save the link topology information to the third non-transitory computer readable memory and send the second acknowledgment message from the third network interface over the first optical transmission section to the first network interface of the first network element; and wherein, upon receiving the second acknowledgment message, the first instructions cause the first processor to save the link topology information in the first non-transitory computer readable medium of the first network element.

In some implementations of the exemplary network, the discover message and the acknowledgment message may further comprise capability information of the first network element.

In one aspect, in accordance with some implementations, the specification describes a network element, comprising: a processor, a network interface connected to a network having a control channel, and a non-transitory computer readable memory storing instructions that, when executed by the processor, cause the network element to: generate a discover message comprising a message identification, a discovered node ID, and a discovered interface ID; send a first signal over the control channel of the network to a second network element, the first signal comprising the discover message; and receive a second signal over the control channel of the network from the second network element, the second signal comprising an acknowledgment message from the second network element, the acknowledgment message being one of a positive acknowledgment message and a negative acknowledgment message; and wherein receipt of the positive acknowledgment message indicates that the message identification, the discovered node ID, and the discovered interface ID in the discover message match identifying data of the second network element, and receipt of the negative acknowledgment indicates that there was at least one mismatch to the identifying data of the message identification, the discovered node ID, and the discovered interface ID in the discover message received by the second network element.

In some implementations of the exemplary network element, the instructions may include a platform adaptation module programmed to configure a protocol of the discover message based on a network layer where the second network element is located as indicated in a layer identification associated with the second network element.

In some implementations of the exemplary network element, the discover message may further comprises capability information of the first network element and the acknowledgment message further comprises capability information of the second network element.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagrammatic view of hardware forming an exemplary optical network having an SNDP system constructed in accordance with one embodiment of the present disclosure.

FIG. 2 is a diagrammatic view of an exemplary user device for use in the SNDP system illustrated in FIG. 1.

FIG. 3 is a diagrammatic view of an exemplary embodiment of a network administration device for use in the SNDP system illustrated in FIG. 1.

FIG. 4 is a diagrammatic view of an exemplary embodiment of an optical node for use in the SNDP system constructed in accordance with one embodiment of the present disclosure.

FIG. 5 is a diagrammatic view of an exemplary embodiment of an optical amplifier for use in the SNDP system constructed in accordance with one embodiment of the present disclosure.

FIG. 6 is a diagrammatic view of an exemplary controller of the optical amplifier illustrated in FIG. 5 for use in the SNDP system constructed in accordance with one embodiment of the present disclosure.

FIG. 7 is a diagram of an example work flow of an exemplary discover message exchange cycle in accordance with one embodiment of the present disclosure.

FIG. 8 is a diagram of an exemplary state cycle of data interfaces illustrating how the SNDP system may transition from one state to another in accordance with one embodiment of the present disclosure.

FIGS. 9A and 9B are diagrams of an example work flow of an exemplary OMS layer discover message exchange cycle in accordance with one embodiment of the present disclosure.

FIGS. 10A and 10B are diagrams of an example work flow of an exemplary discover message exchange cycle that includes link topology discovery in accordance with one embodiment of the preset disclosure.

FIG. 11 is a diagram of an example work flow of an exemplary notify message forwarding cycle in accordance with one embodiment of the present disclosure.

FIG. 12A is a diagrammatic view of interfaces each having a dedicated control-channel used for communication constructed in accordance with one embodiment of the preset disclosure.

FIG. 12B is a diagrammatic view of interfaces having a shared control-channel used for communication constructed in accordance with one embodiment of the preset disclosure.

FIG. 13 is a hypothetical table representing possible information that may be included in a discover message.

FIG. 14 is a hypothetical table representing possible information that may be included in a positive acknowledgment message.

FIG. 15 is a hypothetical table representing possible information that may be included in a negative acknowledgment message.

FIG. 16 is a hypothetical node information table representing possible node configuration attributes or information that may be used in the SNDP.

FIG. 17 is a hypothetical data interface information table representing possible data interface configuration attributes or information that may be used in the SNDP.

FIG. 18 is a hypothetical control channel information table representing possible control channel configuration attributes or information that may be used in the SNDP.

FIG. 19 is a hypothetical OMS Connection information table representing possible OMS Connection configuration attributes or information that may be used in the SNDP.

FIG. 20 is a hypothetical interface state information table representing possible attributes or states that may be associated with an interface using the SNDP.

FIG. 21 is a hypothetical nodal information state table representing possible attributes or states that may be associated with a node using the SNDP.

FIG. 22 is a hypothetical alarms and events table representing possible events/alarms used by the SNDP.

### DETAILED DESCRIPTION

The following detailed description of example embodiments refers to the accompanying drawings. The same reference numbers in different drawings may identify the same or similar elements.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, and combinations thereof, for example.

As used herein, the term “substantially” means that the subsequently described parameter, event, or circumstance completely occurs or that the subsequently described parameter, event, or circumstance occurs to a great extent or degree. For example, the term “substantially” means that the subsequently described parameter, event, or circumstance occurs at least 90% of the time, or at least 91%, or at least 92%, or at least 93%, or at least 94%, or at least 95%, or at least 96%, or at least 97%, or at least 98%, or at least 99%, of the time, or means that the dimension or measurement is within at least 90%, or at least 91%, or at least 92%, or at least 93%, or at least 94%, or at least 95%, or at least 96%, or at least 97%, or at least 98%, or at least 99%, of the referenced dimension or measurement.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein any reference to “one implementation”, “an implementation”, “some implementations”, “one embodiment”, or “an embodiment” means that a particular element, feature, structure, or characteristic described in connection with the implementation is included in at least one implementation. The appearances of the phrase “in one embodiment” or “in one implementation” in various places in the specification are not necessarily all referring to the same embodiment.

Circuitry, as used herein, may be analog and/or digital components, or one or more suitably programmed processors (e.g., microprocessors) and associated hardware and software, or hardwired logic. Also, “components” may perform one or more functions. The term “component” may include hardware, such as a processor (e.g., microprocessor), a combination of hardware and software, and/or the like. Software may include one or more computer executable instructions that when executed by one or more components cause the component to perform a specified function. It should be understood that the algorithms described herein may be stored on one or more non-transitory memory. Exemplary non-transitory memory may include random access memory, read only memory, flash memory, non-volatile memory, and/or the like. Such non-transitory memory may be electrically based, optically based, and/or the like.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, a “route” and/or an “optical route” may correspond to an optical path and/or an optical light path. For example, an optical route may specify a path along which light is carried between two or more network entities.

As used herein, an optical link may be an optical fiber, an optical channel, an optical super-channel, a super-channel group, an optical carrier group, a set of spectral slices, an optical control channel (e.g., sometimes referred to herein as an optical supervisory channel or an “OSC”), an optical data channel (e.g., sometimes referred to herein as “BAND”), and/or any other optical signal transmission link. An optical link may be composed of spectral slices pertaining to C-Band and/or L-Band spectrum. C+L Band spectrum has about 9.6 THz worth of optical bandwidth (i.e., 4.8 THz×2).

In some implementations, an optical super-channel may include multiple channels multiplexed together using wavelength-division multiplexing in order to increase transmission capacity. Various quantities of channels may be combined into super-channels using various modulation formats to create different super-channel types having different characteristics. Additionally, or alternatively, a super-channel group may include multiple super-channels multiplexed together using wavelength-division multiplexing in order to increase transmission capacity.

Additionally, or alternatively, an optical link may be a set of spectral slices. A spectral slice (a “slice”) may represent a spectrum of a particular size in a frequency band (e.g., 12.5 gigahertz (“GHz”), 6.25 GHz, etc.). For example, a 4.8 terahertz (“THz”) frequency band may include 384 spectral slices, where each spectral slice may represent 12.5 GHz of the 4.8 THz spectrum. A super-channel may include a different quantity of spectral slices depending on the super-channel type.

As used herein, a transmission line segment (which may be referred to as an optical link or an optical multiplex section) is the portion of a transmission line from a first node (e.g., ROADM) transmitting a transmission signal to a second node (e.g., ROADM) receiving the transmission signal. The transmission line segment may include one or more optical in-line amplifier situated between the first node and the second node. In some implementations, an optical multiplex section (OMS) has the same scope as the transmission line segment (TLS). In some implementations, the OMS may be a subset of a TLS. In some implementations, OMS-C(C-Band) and OMS-L (L-Band) may be combined together in an optical link or TLS. In some implementations, TLS may be used synonymously with Optical Link. An Optical Link may be composed of OMS-C and OMS-L

As used herein, an optical span is a portion of an optical transmission line from a first network element (e.g., ROADM, optical amplifier, etc.) transmitting a transmission signal to a next network element (e.g., ROADM, optical amplifier, etc.) in the optical transmission line that receives the transmission signal. For instance, in an exemplary transmission line segment, a first optical span may connect a first ROADM to a first optical amplifier, a second optical span may connect the first optical amplifier to a second optical amplifier, and a third optical span may connect the second optical amplifier to a second ROADM.

Amplified spontaneous emission (ASE) is light produced by spontaneous emission that has been optically amplified by the process of stimulated emission in a gain medium. ASE is light that is incoherent and causes perturbations on the optical link. Every optical amplifier, e.g., EDFAs and Raman amplifiers, emit ASE. If an amplified spontaneous emission power level is too high relative to the transmission signal power level, the transmission signal in the fiber optic cable will be unreadable due to a low signal to noise ratio.

Transmission launch power may include a spectral power, which may be described in decibel-milliwatts (dBm or dBmW), of a transmission signal after each transmitter or amplifier.

As used herein, the C-Band is a band of light having a wavelength between 1528.6 nm and 1566.9 nm. The L-Band is a band of light having a wavelength between 1569.2 nm and 1609.6 nm. Because the wavelength of the C-Band is smaller than the wavelength of the L-Band, the wavelength of the C-Band may be described as a short, or a shorter, wavelength relative to the L-Band. Similarly, because the wavelength of the L-Band is larger than the wavelength of the C-Band, the wavelength of the L-Band may be described as a long, or a longer, wavelength relative to the C-Band.

As used herein, a reconfigurable optical add-drop multiplexer (ROADM) node refers to an all-optical subsystem that enables remote configuration of wavelengths at any ROADM node. A ROADM is software-provisionable so that a network operator can choose whether a wavelength is added, dropped, or passed through the ROADM node. The technologies used within the ROADM node include wavelength blocking, planar light wave circuit (PLC), and wavelength selective switching (WSS)—though the WSS has become the dominant technology. A ROADM system is a metro/regional wavelength division multiplexing (WDM) or long-haul dense wavelength division multiplexing (DWDM) system that includes a ROADM node. ROADMs are often talked about in terms of degrees of switching, ranging from a minimum of two degrees to as many as eight degrees, and occasionally more than eight degrees. A “degree” is another term for a switching direction and is generally associated with a transmission fiber pair. A two-degree ROADM node switches in two directions, typically called East and West. A four-degree ROADM node switches in four directions, typically called North, South, East, and West. In a WSS-based ROADM network, each degree requires an additional WSS switching element.

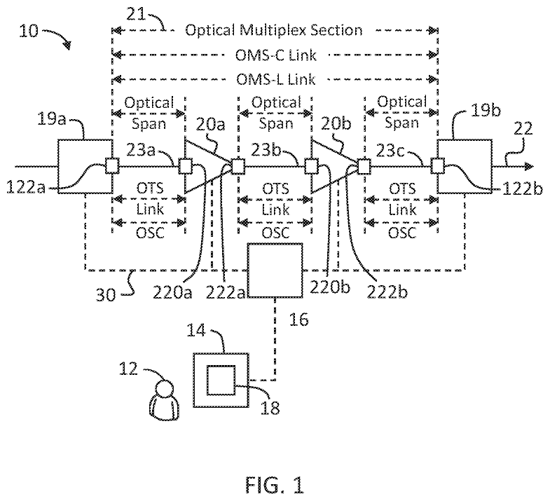

FIG. 1 is a diagrammatic view of hardware forming an exemplary system 10 for implementing a simple neighbor discovery protocol (SNDP) constructed in accordance with one implementation of the present disclosure.

In general, SNDP is a control plane protocol that may be utilized with a local first network element 19a (which, as an example, may be referred to as a first optical node 19a) having one or more first ports 122a in a network 22 (such as an optical network 22), and configured for use in discovering an existence of one or more other “neighbor” network element (for example, second network element 19b (which, as an example, may be referred to as a second optical node 19b) or one or more optical amplifiers 20a-n) and associated ports (for example, one or more second port(s) 122b-n of the second optical node 19b and/or port 220a of optical amplifier 20a) that are connected to the first port 122a on the first local network element 19a, and in discovering the capabilities of the neighboring network element(s) (for example, second optical node 19b or one or more optical amplifiers 20a-n). SNDP allows neighbor discovery to be defined at a link (or span) level. In other words, neighbor network elements may be different for different links or network spans. For instance, in the exemplary optical network 22, the first optical node 19a has different neighbors on interfaces pertaining to optical transmission section (OTS) 23a and optical multiplex section (OMS) 21 though they are bound to the same physical port (i.e., interface 122a). The second optical node 19b is the neighbor of the first optical node 19a over optical multiplex section 21 and a first optical amplifier 20a is a neighbor of the first optical node 19a over a first optical transmission section 23a.

While the first network element 19a and the second network element 19b are described herein in the context of an optical network and referred to as first optical node 19a and second optical node 19b, it should be noted that in other network and/or layer types the first and second network elements 19a, 19b may be different types of nodes. For instance, in a layer 1 network, the first and second network elements 19a, 19b may be TDM switches and/or muxponders. In a layer 2 network, the first and second network elements 19a, 19b may be ethernet switches. In a layer 3 network, the first and second network elements 19a, 19b may be IP routers.

Further, because the SNDP protocol is layer independent, SNDP allows discovery of neighbor network elements in each of different layers. For example, the first network element 19a and the second network element 19b may be in layer 0, and the first and second network elements 19a, 19b may be optical nodes, such as a ROADM1 and a ROADM2. In an example, the first network element 19a and the second network element 19b may be in layer 1, and the first and second network elements 19a, 19b may be TDM switches or muxponders, such as a TDM-Switch1 and a TDM-Switch 2. In an example, the first network element 19a and the second network element 19b may be in layer 2, and the first and second network elements 19a, 19b may be Ethernet Switches, such as an Ethernet-Switch1 and an Ethernet-Switch 2. In an example, the first network element 19a and the second network element 19b may be in layer 3, and the first and second network elements 19a, 19b may be IP routers, such as an IP-Router1 and an IP-Router 2. In such implementations, SNDP allows bi-directional discovery between the neighboring network elements in each of the different layers.

SNDP is layer independent in that it can be used in different layers and is not limited to a configuration for any particular layer. SNDP may be an interface-orientated protocol, in which messages may be exchanged on behalf of ports 122 (which may be referred to as data interfaces 122 or data ports 122) of the network elements 19.

SNDP may support discovery of ports 122b-n of neighboring (second) network elements 19b-n to the first network element 19a, that are connected over point-to-point links within the network 22. SNDP may utilize control channels for discovery.

In some implementations, a particular control channel used for the discovery may be dedicated to a given data port 122. In some implementations the particular control channel used for the discovery may be shared across multiple data ports 122.

SNDP may define Protocol-Data-Units (PDUs) and behavior associated with the discovery process. The mechanisms for packet encapsulation and transport of the PDUs, as will be described below, may be used with a variety of control channels with different characteristics, such as control channels associated with different network transport layers, including Layer 0 (Optical Layer), Layer 1 (Digital Layer), and Layer3 (IP Layer). For example, SNDP may be used with an Optical Supervisory Channel in Layer 0. Additionally, SNDP may be used with Layer 2 (Ethernet). The transport mechanism for the PDUs may be different for each layer.

In some implementations, a user 12 may interact with the system 10 using a user device 14 that may be used to request, from a network administration device 16, a graphical user interface 18 (hereinafter “GUI 18”) configured to accept input from the user 12 that may be transmitted to one or more of the network elements 19, for example, such as the one or more of the first optical node 19a and/or the second optical node 19b and/or one or more optical amplifier 20 such as a first optical amplifier 20a and/or a second optical amplifier 20b of an optical network 22.

In some implementations, the network administration device 16 may be connected to the optical network 22 and the user device 14 via a network 30. In some implementations, the network 30 may be the Internet and/or other network. For example, if the network 30 is the Internet, the GUI 18 of the system 10 may be delivered through a series of web pages or private internal web pages of a company or corporation, which may be written in hypertext markup language. It should be noted that the GUI 18 of the system 10 may be another type of interface including, but not limited to, a Windows-based application, a tablet-based application, a mobile web interface, an application running on a mobile device, and/or the like.

The network 30 may be almost any type of network. For example, in some embodiments, the network 30 may be a version of an Internet network (e.g., exist in a TCP/IP-based network). It is conceivable that in the near future, embodiments within the present disclosure may use more advanced networking technologies.

The optical network 22 may include any type of network that uses light as a transmission medium. For example, the optical network 22 may include a wavelength division multiplexed optical communication system, a fiber-optic based network, an optical transport network, a laser diode network, an infrared network, and/or a combination of these or other types of optical networks. The optical network 22 may be provided with one or more of the optical amplifiers 20, which are represented for explanatory purposes as a first optical amplifier 20a and a second optical amplifier 20b.

The one or more optical nodes 19 may be a network element with a collection of modules supporting interfaces such as port 122 through which data may be exchanged. The modules may be Layer 0 or Layer 1 modules, for example. In some implementations, the optical nodes 19 may be single chassis network element, or multiple chassis network element, configured to accept cards. Nonexclusive examples of optical nodes 19 include transceivers, optical amplifiers, and reconfigurable add-drop multiplexers (ROADM). The optical node 19 may have one or more ports 122. The port 122 may be an external physical port or a logical port, for example. The port 122 may be configured to accept a connection with an optical fiber.

An optical transmission section (OTS) 23 (shown as first, second, and third optical transmission sections 23a, 23b, 23c in the figures for exemplary purposes), may connect optical nodes 19a-n and optical amplifiers 20a-n in the optical network 22.

As used herein, optical multiplex section (OMS) 21 refers to a connection between two ROADM sites or nodes, such as the first optical node 19a and the second optical node 19b. As illustrated in FIG. 1, an optical multiplex section 21 may be comprised of one or more OTS 23 such as the first OTS 23a that connects the first optical node 19a to the first optical amplifier 20a, the second OTS 23b that connects the first optical amplifier 20a to the second optical amplifier 20b, and the third OTS 23c that connects the second optical amplifier 20b to the second optical node 19b. The OMS 21 may be referred to herein as an optical link 21. The OTS 23 may be referred to herein as an optical span 23.

Each OTS 23 has an associated optical supervisory channel (OSC). The OSC terminates at the end of each OTS 23. However, the OMS 21 (which may include a C Band and an L Band) runs between optical nodes 19, such as between the first optical node 19a and the second optical node 19b, and may pass through multiple OTSs 23, such as through the first, second, and third OTS 23a, 23b, 23c. Therefore, SNDP messages between optical nodes 19, such as between the first optical node 19a and the second optical node 19b, may be forwarded by optical amplifiers 20 that may be positioned between the nodes 19, such as the first and second optical amplifiers 20a, 20b. To facilitate this forwarding, SNDP messages may include link-specific addresses that indicate whether an intended recipient of the SNDP message is associated with the OMS 21 or a particular OTS 23. For instance, if the SNDP message includes an address (which may be a multicast address) that indicates the SNDP message is intended for an OMS recipient, the first and second optical amplifiers 20a, 20b may be programmed to transparently forward (that is, forward as received, without any change) the SNDP message.

SNDP PDUs can be transported directly over Ethernet or IP packets. Since the exchange is point-to-point, multicast destination address may be used for the transport. Note that the system 10 may be provided with a multicast address configured to terminate on ROADMs (such as the first optical node 19a and the second optical node 19b) only. Any PDU sent using such a multicast address will be express forwarded (e.g., transparently forwarded) by the optical amplifiers (such as the first and second optical amplifiers 20a, 20b). The system 10 may be provided with another multicast address configured to terminate at each network element (i.e., on all optical nodes 19 and all optical amplifiers 20). Both OMS layer messages and OTS layer messages may be terminated on the optical amplifiers 20. The OTS layer messages may be terminated and consumed locally by the optical amplifiers. The OMS layer messages may be forwarded from east to west and vice-versa by an OMS forwarding function.

In some embodiments, SNDP messages may be configured to include topology discovery which gathers information regarding a topology of an optical multiplex section such as optical multiplex section 21 of a network such as the network 22 as the SNDP message is forwarded between network elements. For instance, an SNDP message sent from the first optical node 19a to the second optical node 19b may gather topology information from the first optical amplifier 20a, the second optical amplifier 20b, and the second optical node 19b and include that topology information in a response SNDP message sent from the second optical node 19b to the first optical node 19a. In some embodiments, the topology information may include capabilities and/or characteristics of the network elements 19 such as the first optical node 19a, the second optical node 19b, the first optical amplifier 20a, and the second optical amplifier 20b. Topology discovery may happen independently for different bands (for example, C-Band and L-Band). Topology discovery may happen independently for forward and backward directions. Topology discovery and capability discovery will be discussed in more detail herein.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of system 10 may perform one or more functions described as being performed by another one or more of the devices of the system 10. Devices of the system 10 may interconnect via wired connections, wireless connections, or a combination of wired and wireless connections.

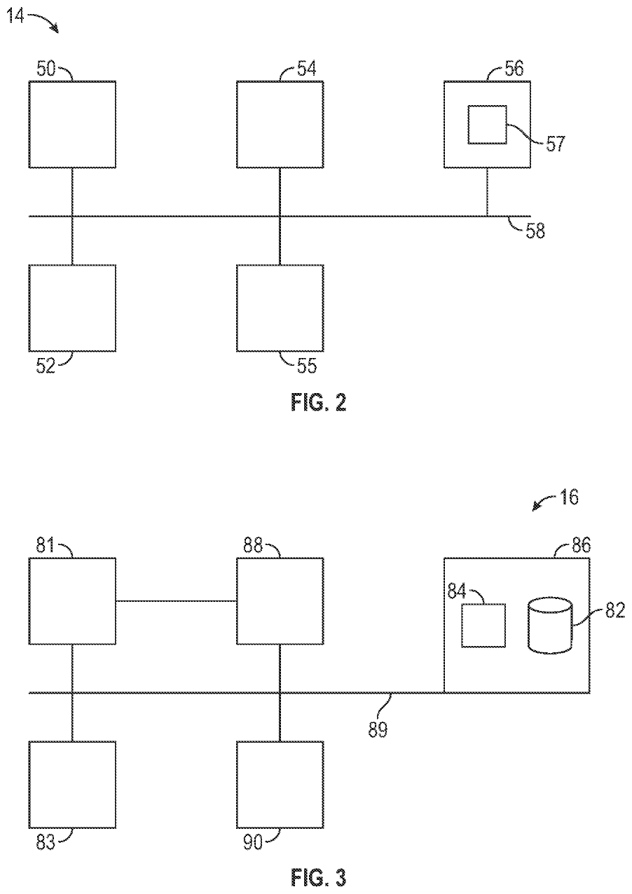

As shown in FIG. 2, the one or more user devices 14 of the system 10 may include, but are not limited to implementation as a personal computer, a cellular telephone, a smart phone, a network-capable television set, a tablet, a laptop computer, a desktop computer, a network-capable handheld device, a server, a digital video recorder, a wearable network-capable device, and/or the like.

In some embodiments, the user device 14 may include one or more input devices 50 (hereinafter “input device 50”), one or more output devices 52 (hereinafter “output device 52”), one or more processors 54 (hereinafter “processor 54”), one or more communication devices 55 (hereinafter “communication device 55”) capable of interfacing with the network 30, one or more non-transitory memory 56 (which may be referred to as non-volatile memory, or simply, “memory 56”) storing processor executable code and/or software application(s), for example including, a web browser capable of accessing a website and/or communicating information and/or data over a wireless or wired network (e.g., network 30), and/or the like. The input device 50, output device 52, processor 54, communication device 55, and memory 56 may be connected via a path 58 such as a data bus that permits communication among the components of user device 14.

The memory 56 may store an application 57 that, when executed by the processor 54 causes the user device 14 to display the GUI 18. In some embodiments, the application 57 is programmed to cause the processor 54 to provide the GUI 18 that allows the user 12 to interact with both historical and real-time information gathered from the network elements 20 as will be described further herein. The input device 50 may be capable of receiving information input from the user 12 and/or processor 54, and transmitting such information to other components of the user device 14 and/or the network 30. The input device 50 may include, but are not limited to, implementation as a keyboard, touchscreen, mouse, trackball, microphone, fingerprint reader, infrared port, slide-out keyboard, flip-out keyboard, cell phone, PDA, remote control, fax machine, wearable communication device, network interface, combinations thereof, and/or the like, for example.

The output device 52 may be capable of outputting information in a form perceivable by the user 12 and/or processor 54. For example, implementations of the output device 52 may include, but are not limited to, a computer monitor, a screen, a touchscreen, a speaker, a website, a television set, a smart phone, a PDA, a cell phone, a fax machine, a printer, a laptop computer, combinations thereof, and the like, for example. It is to be understood that in some exemplary embodiments, the input device 50 and the output device 52 may be implemented as a single device, such as, for example, a touchscreen of a computer, a tablet, or a smartphone. It is to be further understood that as used herein the term user 12 is not limited to a human being, and may comprise, a computer, a server, a website, a processor, a network interface, a human, a user terminal, a virtual computer, combinations thereof, and/or the like, for example.

The network administration device 16 may be capable of interfacing and/or communicating with the user device 14 via the network 30. For example, the network administration device 16 may be configured to interface by exchanging signals (e.g., analog, digital, optical, and/or the like) via one or more ports (e.g., physical ports or virtual ports) using a network protocol, for example. Additionally, each network administration device 16 may be configured to interface and/or communicate with other network administration device 16 directly and/or via the network 30, such as by exchanging signals (e.g., analog, digital, optical, and/or the like) via one or more ports.

The network 30 may permit bi-directional communication of information and/or data between the network administration device 16, the user device 14, and/or the optical amplifiers 20. The network 30 may interface with the network administration device 16, the user device 14, and/or the optical amplifiers 20 in a variety of ways. For example, in some embodiments, the network 30 may interface by optical and/or electronic interfaces, and/or may use a plurality of network topographies and/or protocols including, but not limited to, Ethernet, TCP/IP, circuit switched path, combinations thereof, and/or the like. For example, in some embodiments, the network 30 may be implemented as the World Wide Web (or Internet), a local area network (LAN), a wide area network (WAN), a metropolitan network, a 4G network, a 5G network, a satellite network, a radio network, an optical network, a cable network, a public switch telephone network, an Ethernet network, combinations thereof, and the like, for example. Additionally, the network 30 may use a variety of network protocols to permit bi-directional interface and/or communication of data and/or information between the network administration device 16, the user device 14 and/or the optical amplifiers 20.

Referring now to FIG. 3, shown therein is a diagrammatic view of an exemplary embodiment of the network administration device 16. The network administration device 16 may include one or more devices that gather, process, search, store, and/or provide information in a manner described herein. In the illustrated embodiment, the network administration device 16 is provided with a least one input device 81 (hereinafter “input device 81”), at least one output device 83 (hereinafter “output device 83”), one or more databases 82 (hereinafter “database 82”), program logic 84, one or more processors 88 (hereinafter “processor 88”), and one or more communication devices 90 (hereinafter “communication device 90”). The program logic 84 and the database 82 may be stored on non-transitory computer readable storage memory 86 (hereinafter “memory 86”) accessible by the processor 88 of the network administration device 16. It should be noted that as used herein, program logic 84 is another term for instructions which can be executed by the processor 54 or the processor 88. The database 82 can be a relational database or a non-relational database. Examples of such databases comprise, DB2®, Microsoft® Access, Microsoft® SQL Server, Oracle®, mySQL, PostgreSQL, MongoDB, Apache Cassandra, and the like. It should be understood that these examples have been provided for the purposes of illustration only and should not be construed as limiting the presently disclosed inventive concepts. The database 82 can be centralized or distributed across multiple systems.

In some embodiments, the network administration device 16 may comprise one or more processors 88 working together, or independently to, execute processor executable code stored on the memory 86. Each element of the network administration device 16 may be partially or completely network-based or cloud-based, and may or may not be located in a single physical location.

The processor 88 may be implemented as a single processor or multiple processors working together, or independently, to execute the program logic 84 as described herein. It is to be understood, that in certain embodiments using more than one processor 88, the processors 88 may be located remotely from one another, located in the same location, or comprising a unitary multi-core processor. The processors 88 may be capable of reading and/or executing processor executable code and/or capable of creating, manipulating, retrieving, altering, and/or storing data structures into the memory 86.

Exemplary embodiments of the processor 88 may be include, but are not limited to, a digital signal processor (DSP), a central processing unit (CPU), a field programmable gate array (FPGA), a graphics processing unit (GPU), a microprocessor, a multi-core processor, combinations, thereof, and/or the like, for example. The processor 88 may be capable of communicating with the memory 86 via a path 89 (e.g., data bus). The processor 88 may be capable of communicating with the input device 81 and/or the output device 83.

The processor 88 may be further capable of interfacing and/or communicating with the user device 14 and/or the optical node 19 or the optical amplifier 20 via the network 30 using the communication device 90. For example, the processor 88 may be capable of communicating via the network 30 by exchanging signals (e.g., analog, digital, optical, and/or the like) via one or more ports (e.g., physical or virtual ports) using a network protocol to provide a pump model to the optical amplifier 20 as will be described in further detail herein.

The memory 86 may be capable of storing processor executable code such as program logic 84. Additionally, the memory 86 may be implemented as a conventional non-transitory memory, such as for example, random access memory (RAM), CD-ROM, a hard drive, a solid-state drive, a flash drive, a memory card, a DVD-ROM, a disk, an optical drive, combinations thereof, and/or the like, for example.

In some embodiments, the memory 86 may be located in the same physical location as the network administration device 16, and/or one or more memory 86 may be located remotely from the network administration device 16. For example, the memory 86 may be located remotely from the network administration device 16 and communicate with the processor 88 via the network 30. Additionally, when more than one memory 86 is used, a first memory 86 may be located in the same physical location as the processor 88, and additional memory 86 may be located in a location physically remote from the processor 88. Additionally, the memory 86 may be implemented as a “cloud” non-transitory computer readable storage memory (i.e., one or more memory 86 may be partially or completely based on or accessed using the network 30).

The input device 81 of the network administration device 16 may transmit data to the processor 88 and may be similar to the input device 50 of the user device 14. The input device 81 may be located in the same physical location as the processor 88, or located remotely and/or partially or completely network-based. The output device 83 of the network administration device 16 may transmit information from the processor 88 to the user 12, and may be similar to the output device 52 of the user device 14. The output device 83 may be located with the processor 88, or located remotely and/or partially or completely network-based.

The memory 86 may store processor executable code and/or information comprising the database 82 and program logic 84. In some embodiments, the processor executable code 84 may be stored as a data structure, such as the database 82 and/or data table, for example, or in non-data structure format such as in a non-compiled text file.

The optical node 19 may include one or more devices that gather, process, store, and/or provide information in a manner described herein. For example, the optical nodes 19 may include one or more optical data processing and/or traffic transfer devices, such as an optical add-drop multiplexer (“OADM”), a reconfigurable optical add-drop multiplexer (“ROADM”), or a flexibly reconfigurable optical add-drop multiplexer module (“FRM”) and/or any type of device capable of processing and/or transferring optical traffic.

In some implementations, the optical node 19 may include OADMs and/or ROADMs capable of being configured to add, drop, multiplex, and demultiplex optical signals. Optical node 19 may process and transmit optical signals to other optical nodes 19 throughout optical network 22 in order to deliver optical transmissions.

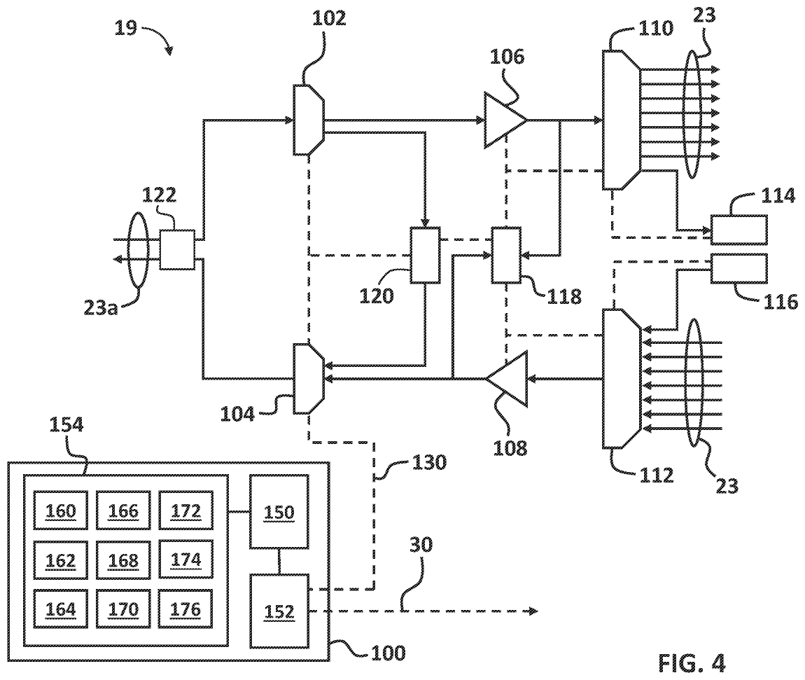

Referring now to FIG. 4, shown therein is a diagrammatic view of an exemplary optical node 19 of the optical network 22 that may be monitored and/or configured according to implementations described herein. In accordance with the present disclosure, the optical node 19 may be a ROADM within the fiber of the optical network 22, that allows dynamic software-driven provisioning of wavelengths in WDM and/or DWDM network services from a remote management system without major network changes or redesign.

The optical node 19 may be provided with a controller 100, an input filter 102, an output filter 104, an input amplifier 106, an output amplifier 108, an output WSS 110, an input WSS 112, at least one add transceiver 114 (hereinafter “add transceiver 114”), at least one drop transceiver 116 (hereinafter “drop transceiver 116”), an optical channel monitor (OCM) 118, an optical supervisory channel (OSC) 120, and one or more of the interfaces 122. It should be noted that the elements of optical node 19 are shown for illustration purposes only and should not be considered limiting. For instance, the illustrated optical node 19 is one possible realization of a single degree of a ROADM. However, the optical node 19 may be implemented as a multi-degree ROADM with a launch power for each optical segment serviced by the optical node 19 implemented in accordance with the inventive concepts described herein. Further, the add transceiver 114 and the drop receiver 116 may be implemented as a line card having multiple add and drop transceivers and may be configured to service channels across multiple ROADM degrees.

The OCM 118 provides the ability to monitor a power level of each wavelength. This information can then be used by the controller 100 to attenuate each wavelength with the output WSS 110 and/or the input WSS 112 at ROADM sites or dynamic gain equalization (DGE) at optical amplifier 20 sites in order to optimize the power level of each wavelength. The OCM 118 can also be used to troubleshoot the optical network 22. Coherent OCMs offer sub-GHz accuracy and highly accurate power monitoring of fine spectral slices independent of adjacent channel power. They reduce the C-band scanning time from seconds to hundreds of milliseconds. And they provide advanced processing of spectral characteristics, such as valid channel detection, center wavelength, and optical signal-to-noise ratio (OSNR).

The OSC 120 provides a communication channel between adjacent network elements, such as the first optical node 19a and the first optical amplifier 20a, for example, or between the first optical amplifier 20a and the second optical amplifier 20b, or between the second optical amplifier 20b and the second optical node 19b, that can be used for functions including link control, in-band management, control plane (i.e., ASON/GMPLS), span loss measurement, and neighbor discovery. Information about the physical properties of the optical network segment 23 (fiber types, loss, amplifier types, etc.) downstream from the optical node 19 can be communicated to the controller 100 via the OSC 120.

The interface 122 may be a physical port or a software port through which data is exchanged with a neighboring network element. For instance, the interface 122 is illustrated a port though which data may be transmitted and/or received over the OTS 23 and OMS 21.

While the optical node 19 is shown as having one interface (interface 122), it should be noted that the optical node 19 may be provided having any number of interfaces 122 known in the art.

The optical node 19 is illustrated with the controller 100 for controlling the elements of the optical node 19. The optical node 19 may be provided with an interface 130 that connects the controller 100 to the elements of the optical node 19.

The controller 100 may be a microcontroller, for instance, that is provided with a processor 150, a communication device 152, and non-transitory computer readable memory 154 (“memory 154”). The controller 100 may perform tasks including the functions related to SNDP described herein. The memory 154 may store executable code such as a configuration module 160, an event updater module 162, a neighbor discovery module 164, a link topology module 166, a security module 168, an inbound message handler 170, an outbound message handler 172, a platform adaptation module 174, and a remote procedure call module 176 that when executed causes the processor 150 to perform tasks that will be described further herein.

The remote procedure call module 176 may be configured to interface with the network administration device 16 and process SNDP specific configuration commands from the network administration device 16.

The configuration module 160 may be configured to interface with the remote procedure call module 176 and processes configuration commands received from the remote procedure call module 176. Once the configuration module 160 processes the configuration commands received from the remote procedure call module 176, the configuration module 160 may be programmed to save the processed configuration commands in the memory 154.

The event updater module 162 may be programmed to stream protocol events and alarm reports. Some exemplary events include, but are not limited to, a neighbor discover event, a neighbor lost event (e.g., a previously discovered neighbor node is no longer associated with an interface), a link topology information changed event, and a neighbor node information changed event. Exemplary alarm events may include, but are not limited to, a neighbor lost alarm (communication with a neighbor node is lost) and a configuration mismatch alarm (local configuration parameter(s) do not match with those received from a neighbor node).

The neighbor discovery module 164 may be programmed to generate discover messages and receive and process positive acknowledgment messages and negative acknowledgment messages as will be described in further detail herein.

The link topology module 166 may be programmed to gather link topology information and forward link topology information as will be described further herein.

The security module 168 may be programmed to provide a security aspect of the SNDP. For instance, the security module 168 may be programmed to provide encryption and authentication mechanisms such as integrity-based authentication.

The inbound message handler 170 and the outbound message handler 172 may be programmed to queue and prioritize messages entering and exiting the SNDP and handing off the messages to the appropriate modules.

The platform adaptation module 174 may be programmed to bind SNDP messaging abstraction with platform specific system calls.

The number of devices illustrated in FIG. 4 are provided for explanatory purposes. In practice, there may be additional devices, fewer devices, different devices, or differently arranged devices than are shown in FIG. 4. Furthermore, two or more of the devices illustrated in FIG. 4 may be implemented within a single device, or a single device illustrated in FIG. 4 may be implemented as multiple, distributed devices. Additionally, one or more of the devices illustrated in FIG. 4 may perform one or more functions described as being performed by another one or more of the devices illustrated in FIG. 4. Devices illustrated in FIG. 4 may interconnect via wired connections (e.g., fiber-optic connections).

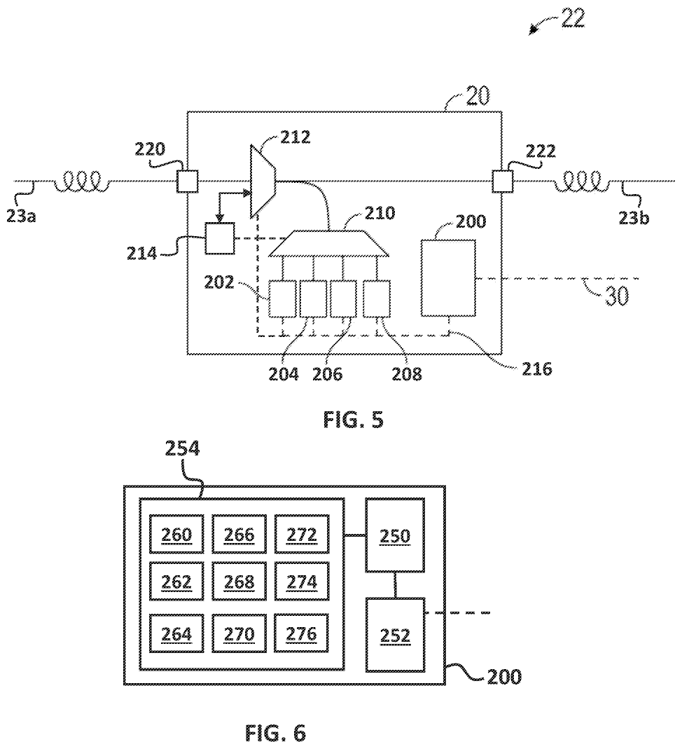

Referring now to FIGS. 5 and 6, shown therein is a diagrammatic view of an exemplary one of the optical amplifier 20, and an exemplary controller of the optical amplifier 20, of the optical network 22 that may be monitored and/or configured according to implementations described herein. In accordance with the present disclosure, in some implementations, the optical amplifier 20 may be a Raman amplifier that makes use of stimulated Raman scattering (SRS) within the fiber of the optical network 22, which transfers the energy of higher-frequency Raman pump signals to lower-frequency carrier signals. The amplification occurs along the fiber of the optical network 22. The typical configuration is a backward pump scheme, as indicated in FIG. 5, which introduces less noise. In practice, a Raman amplifier uses multiple pump lasers to realize high gain and flatness. Using a polarization multiplexer, such as pump combiner 210, two or more Raman pumps, such as two or more of a first, second, third, and fourth Raman pump 202, 204, 206, and 208, with a same center frequency can be used to pump power and reduce a polarization dependency of Raman gain. When using a different wavelength, pump power of the Raman pumps 202, 204, 206, and 208 can be increased, and bandwidth may be enlarged as well. By adjusting the ratio of these Raman pump powers, optical amplifier 20 can achieve flat gain. To obtain optimum performance, a power of each Raman pump 202, 204, 206, and 208 has to be set according to a signal spectrum of a carrier signal received by the optical amplifier 20.

The optical amplifier 20 is illustrated with a controller 200 for controlling the first, second, third, and fourth Raman pumps 202, 204, 206, and 208 of the optical amplifier 20, pump combiner 210, a WDM 212, optical supervisory channel (OSC) 214, an interface 216 that connects the controller 200 to the Raman pumps 202, 204, 206, and 208, the pump combiner 210, the WDM 212, the OSC 214, a first interface 220, and a second interface 222.

The first interface 220 and the second interface 222 may be physical ports or software ports through which data is exchanged with a neighboring network element. For instance, the first interface 220 is illustrated as a “west” port though which data may be transmitted or received over the OTS 23a and the second interface 222 is illustrated as an “east” port through which data may be transmitted or received over the OTS 23b.

The optical amplifier 20 is shown having two interfaces, the first interface 220 and the second interface 222. However, it should be noted that the optical amplifier 20 may be provided having any number of interfaces known in the art.

As shown in FIG. 5, the controller 200 may be a microcontroller, for instance, that is provided with a processor 250, a communication device 252, and non-transitory computer readable memory 254 (“memory 254”). The memory 254 may store executable code such as a configuration module 260, an event updater module 262, a neighbor discovery module 264, a link topology module 266, a security module 268, an inbound message handler 270, an outbound message handler 272, a platform adaptation module 274, and a remote procedure call module 276 that when executed causes the processor 250 to perform tasks that will be described further herein.

The remote procedure call module 276 may be configured to interface with the network administration device 16 and process SNDP specific configuration commands from the network administration device 16.

The configuration module 260 may be configured to interface with the remote procedure call module 276 and processes configuration commands received from the remote procedure call module 276. Once the configuration module 260 processes the configuration commands received from the remote procedure call module 276, the configuration module 260 may be programmed to save the processed configuration commands in the memory 254.

The event updater module 262 may be programmed to stream protocol events and alarm reports. Some exemplary events include, but are not limited to (as shown in FIG. 22), a neighbor discover event, a neighbor lost event (e.g., a previously discovered neighbor node is no longer associated with an interface), a link topology information changed event, and a neighbor node information changed event. Exemplary alarm events may include, but are not limited to, a neighbor lost alarm (communication with a neighbor node is lost) and a configuration mismatch alarm (local configuration parameter(s) do not match with those received from a neighbor node).

The neighbor discovery module 264 may be programmed to generate discover messages and receive and process positive acknowledgment messages and negative acknowledgment messages as will be described in further detail herein.

The link topology module 266 may be programmed to gather link topology information and forward link topology information as will be described further herein.

The security module 268 may be programmed to provide a security aspect of the SNDP. For instance, the security module 268 may be programmed to provide encryption and authentication mechanisms such as integrity-based authentication.

The inbound message handler 270 and the outbound message handler 272 may be programmed to queue and prioritize messages entering and exiting the SNDP and handing off the messages to the appropriate modules.

The platform adaptation module 274 may be programmed to bind SNDP messaging abstraction with platform specific system calls.

It should be noted that the optical amplifier 20 is described as a Raman amplifier for the purposes of illustration only and optical amplifier 20 may be any type of optical amplifier.

The number of devices illustrated in FIGS. 5 and 6 are provided for explanatory purposes. In practice, there may be additional devices, fewer devices, different devices, or differently arranged devices than are shown in FIGS. 5 and 6. Furthermore, two or more of the devices illustrated in FIGS. 5 and 6 may be implemented within a single device, or a single device illustrated in FIG. 5 may be implemented as multiple, distributed devices. Additionally, one or more of the devices illustrated in FIG. 5 may perform one or more functions described as being performed by another one or more of the devices illustrated in FIG. 5. Devices illustrated in FIG. 5 may interconnect via wired connections (e.g., fiber-optic connections).

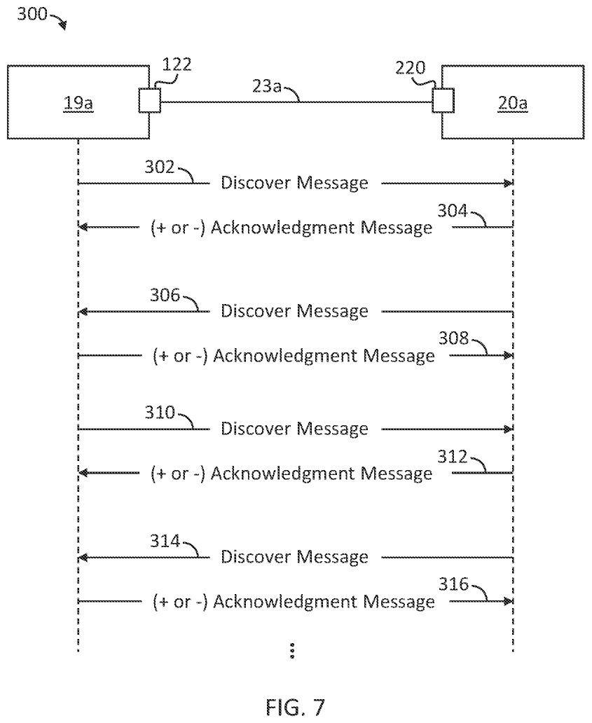

Referring now to FIG. 7, shown therein is an exemplary workflow diagram illustrating an exemplary discover message exchange cycle 300 between network elements such as first optical node 19a and first optical amplifier 20a over the first OTS 23a. In step 302, the first optical node 19a may generate and send a first discover message to the first optical amplifier 20a. The first discover message may be used to initiate and/or maintain a local interface (e.g., interface 122 of the first optical node 19a) to neighbor interface (e.g., the first interface 220 of the first optical amplifier 20a) association. Discover messages may be generated at predetermined time intervals referred to as a discovery-cycle. In some implementations, the time intervals may be periodic. The time intervals for the discovery-cycle may be configured by a user based on network operation needs. For instance, a shorter discovery-cycle (e.g., 10 seconds) may be used in a network where it is optimal or necessary to catch changes quickly. In another example, a longer discovery-cycle (e.g., 120 seconds) may be used in an established network where changes are less likely. Exemplary discover-cycles may be between 10 seconds and 300 seconds. In one exemplary embodiment, the discover-cycle is 30 seconds.

The first discover message may be originated as soon as the neighbor interface (e.g., first interface 220) is created and/or connected and associated with a control channel such as OSC 120 of the first optical node 19a.

The first discover message may include a message-ID which may be an incrementing number generated by the sending node (the first optical node 19a in this example). The message-ID is an ever-increasing number that may be reset from time to time, for instance, when the first optical node 19a is restarted. The message-ID is used to detect out-of-order acknowledgment messages sent from the receiving network element, in this exemplary implementation the first optical amplifier 20a. In an exemplary operation, the first optical amplifier 20a (which may be referred to as a remote node or neighbor node) reflects the Message-ID in a first acknowledgment message in step 304. On receipt of the first acknowledgment message, the first optical node 19a (which may be referred to as a head node or local node) uses the reflected message-ID to correlate to the first discover message sent by the optical node 19a. If an invalid and/or out-of-date Message-ID is received by the first optical node 19a in the first acknowledgment message, the first optical node 19a does not process the first acknowledgment message. This is treated as a response miss.

The first discover message may be sent using the OSC 120 on the first optical node 19a and received by the OSC 214 on the first optical amplifier 20a. When the first optical node 19a generates the first discover message, the first optical node 19a may be programmed to include source node, source control channel, and source interface information such as a source node ID (a unique identifier of the first optical node 19a which may be referred to as SRC_NODE_ID), a source interface ID (a unique identifier of the source interface such as the interface 122 which may be referred to as SRC_INTF_ID), and a source control channel address (e.g., an IPv4 or IPv6 address associated with the source control channel OSC 120 which may be referred to as SRC_CC_IP_ADDR) in the first discover message. The source interface ID and the source control channel address may be used to map a return packet (such as the first acknowledgment message) to an appropriate interface (e.g., interface 122). Upon receipt of the first discover message, the first optical amplifier 20a may be programmed to store an association of the source node ID, the source interface ID, and the source control channel address with the first optical node 19a in the memory 254, for instance. This association may be used to correlate future discover messages as will be described further herein.

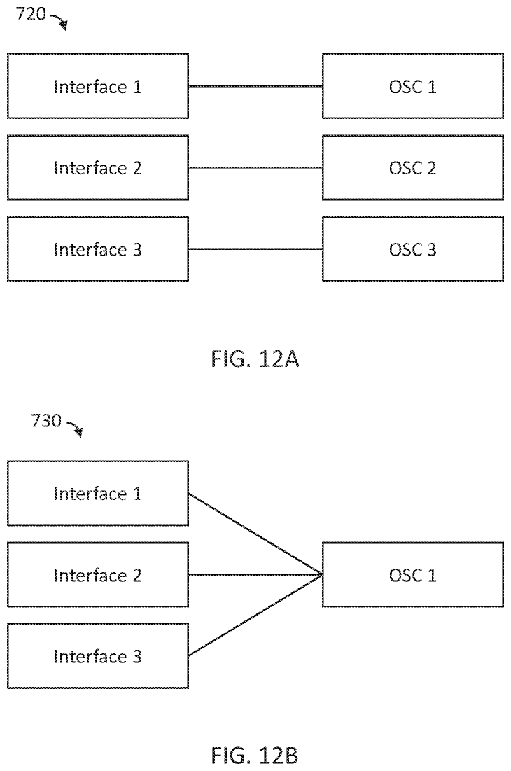

The first discover message may include other information and/or parameters as illustrated in table 800 of FIG. 12.

Referring now to step 304, the first acknowledgment message may be positive or negative. A positive acknowledgment message indicates that correlation of the discover message at the first optical amplifier 20a was successful as will be described further herein. A negative acknowledgment message indicates that correlation of the discover message at the first optical amplifier 20a was not successful as will be described further herein. The first acknowledgment message (positive or negative) must reflect the message-ID of the discover message sent by the first optical node 19a. Further, the first acknowledgment message may use the source interface ID and the source control channel address to map the first acknowledgment message to the appropriate interface (e.g., interface 122).

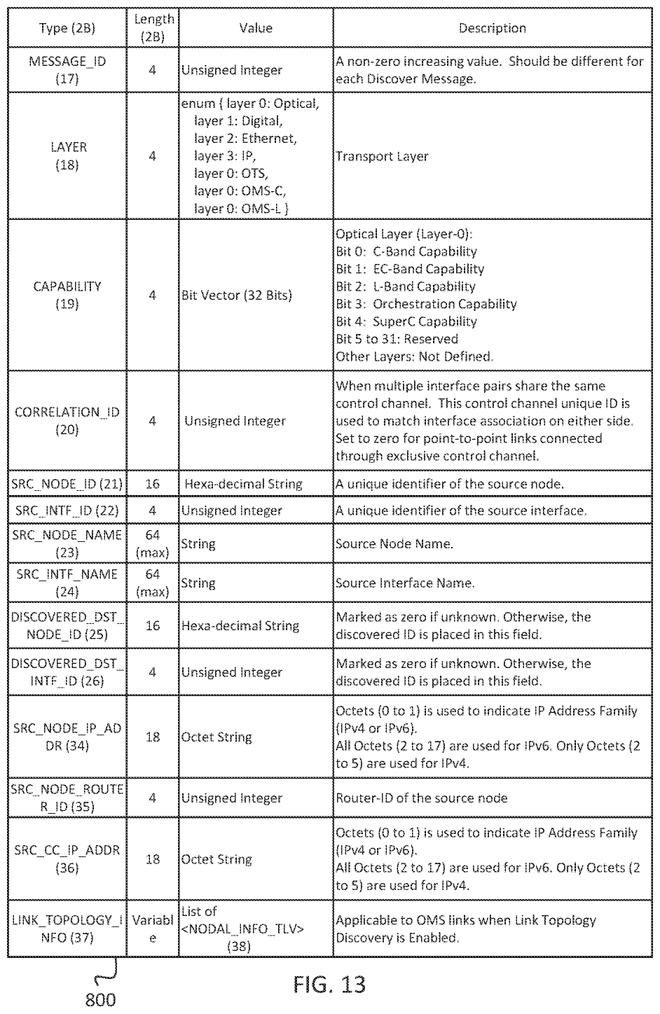

A positive acknowledgment message may include other information or parameters as illustrated in table 850 of FIG. 13.

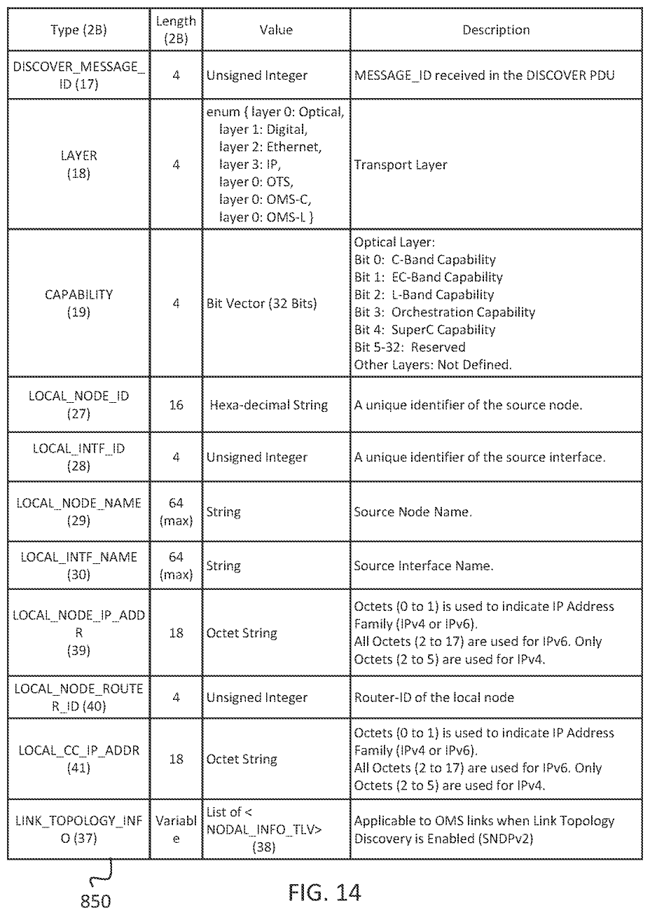

A negative acknowledgment message may include other information or parameters as illustrated in table 900 of FIG. 14.

The first optical amplifier 20a may be programmed to include a local node ID (a unique identifier of the first optical amplifier 20a that may be referred to as LOCAL_NODE_ID), a local interface ID (a unique identifier of the first interface 220 which may be referred to as LOCAL_INTF_ID), and a local control channel address (e.g., an IPv4 or IPv6 address associated with the first optical amplifier 20a control channel OSC 214 which may be referred to as LOCAL_CC_IP_ADDR) in the first acknowledgment message. Upon receipt of the first acknowledgment message, the first optical node 19a may be programmed to store the local node ID, local interface ID, and the local control channel address in the memory 154 associated with the first optical amplifier 20a.

In step 306, the first optical amplifier 20a may generate a second discover message which may include a second message-ID and may send the second discover message to the first optical node 19a. In some embodiments, the second discover message may further include a discovered node ID (the source node ID of the first optical node 19a stored in the memory 254 of the first optical amplifier 20a) and a discovered interface ID (the source interface ID of the first optical node 19a stored in the memory 254 of the first optical amplifier 20a).

In step 308, the first optical node 19a may correlate the second discover message and return a second acknowledgment message (which may be positive or negative) to the first optical amplifier 20a. The first optical node 19a may correlate the second discover message by comparing the discovered node ID with the unique identifier of the first optical node 19a and the discovered interface ID with the unique identifier of the interface 122. If both the discovered node ID and the discovered interface ID match, the second acknowledgment message will be a positive acknowledgment message. If either of the discovered node ID or the discovered interface ID do not match, the second acknowledgment message will be a negative acknowledgment message.

In step 310, after a discovery-cycle, the first optical node 19a may generate a third discover message which includes a third message-ID and sends the third discover message to the first optical amplifier 20a. In some embodiments, the third discover message may further include a discovered node ID (the local node ID of the optical amplifier 20a stored in the memory 154 of the first optical node 19a) and a discovered interface ID (the local interface ID of the first optical amplifier 20a stored in the memory 154 of the first optical node 19a).

In step 312, the first optical amplifier 20a may correlate the third discover message and return a third acknowledgment message (which may be positive or negative) to the first optical node 19a. The first optical amplifier 20a may correlate the third discover message by comparing the discovered node ID with the unique identifier of the first optical amplifier 20a and the discovered interface ID with the unique identifier of the interface 220. If both the discovered node ID and the discovered interface ID match, the third acknowledgment message will be a positive acknowledgment message. If either of the discovered node ID or the discovered interface ID do not match, the third acknowledgment message will be a negative acknowledgment message.

In step 314, after a discovery-cycle, the first optical amplifier 20a may generate a fourth discover message and send the fourth discover message to the first optical node 19a.

In step 316, the first optical node 19a may correlate the fourth discover message and send a fourth acknowledgment message (which may be positive or negative) to the first optical amplifier 20a.

This exemplary discover message exchange cycle 300 between network elements 19 such as the first optical node 19a and the first optical amplifier 20a may continue for “n” number of cycles or until a state of one or both of the first optical node 19a and/or the first optical amplifier 20a changes, as will be described further herein.

In some implementations, one or more of the first optical node 19a and/or the first optical amplifier 20a may be placed in a Protocol-Administrative-State. In the Protocol-Administrative-State, the local interface (e.g., the second interface 124 of the first optical node 19a or the first interface 220 of the first optical amplifier 20a) is locked, which means that discover messages are neither generated nor are incoming discover message processed. In other words, the discover message exchange cycle 300 is paused while one or more of the first optical node 19a and/or the first optical amplifier 20a is in the Protocol-Administrative-State.

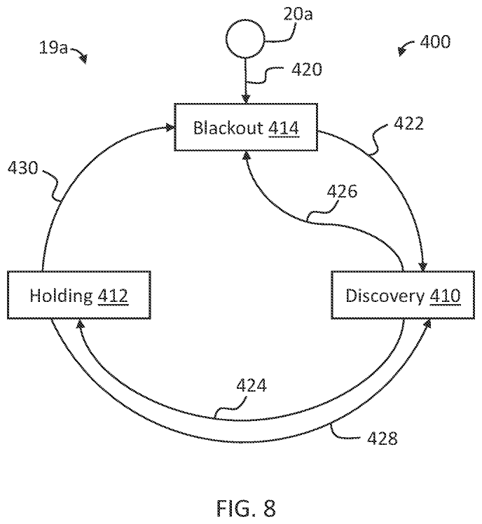

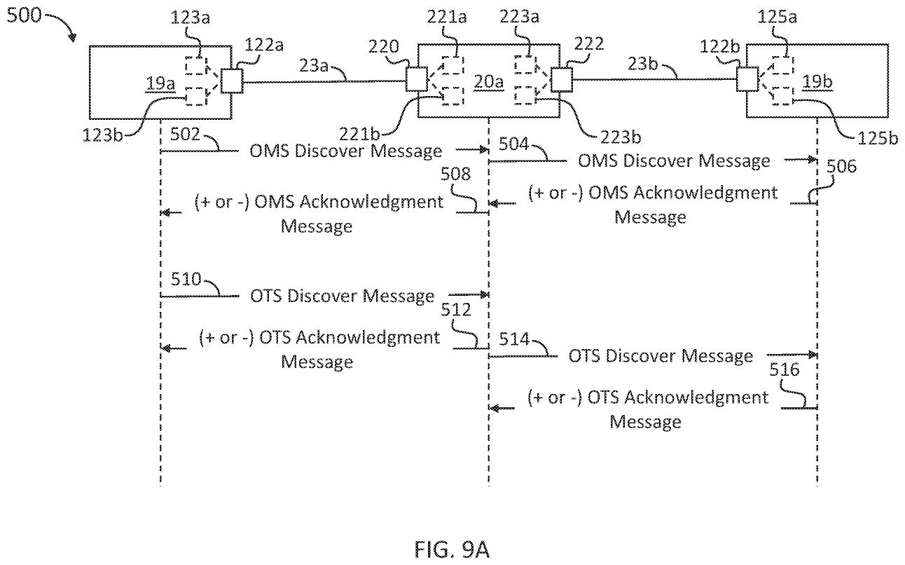

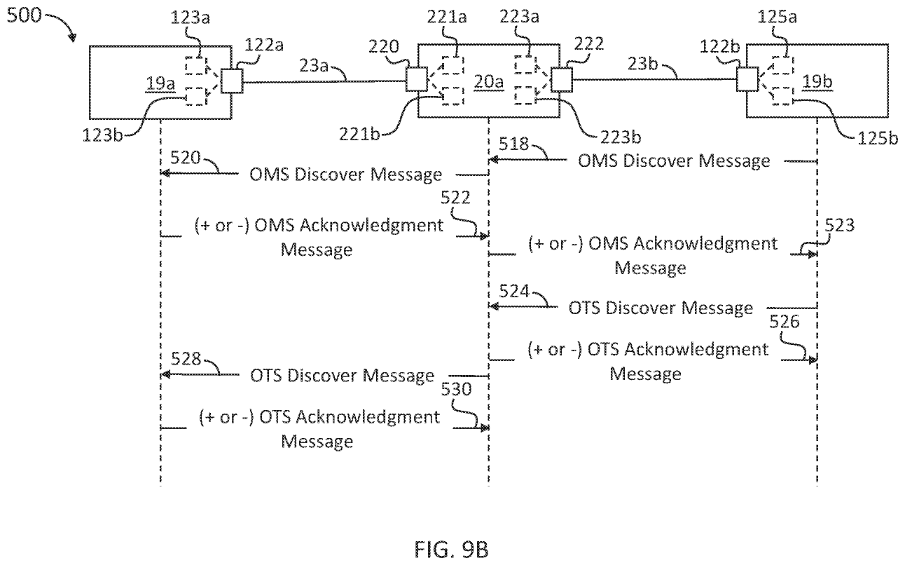

Referring now to FIG. 8, shown therein is an exemplary state cycle 400 of data interfaces illustrating how a network element such as the first optical node 19a transitions each associated interface from one state to another state, such as based on responses (or non-responses) from neighboring network elements (a “discovery state”). For the purposes of illustration, the first optical node 19a will be referred to as a local node 19a and the first optical amplifier 20a will be referred to as a neighbor node 20a. It should be noted, however, that exemplary state cycle 400 may be performed between any neighboring network elements. For instance, the exemplary state cycle 400 may be performed with the first optical amplifier 20a being the local node and the first optical node 19a being the neighbor node. It should be noted that the state cycle 400 may be performed for each associated logical and/or physical interface independently. For example, first optical node 19a has a first logical interface 123a (see FIG. 9) associated with the second optical node 19b over OMS 21 and a second logical interface 123b (see FIG. 9) associated with the first optical amplifier 20a over the first OTS 23a though they are bound to the same physical port (i.e., port 122a). Thus, the first optical node 19a may have a first state cycle 400a running for the first logical interface 123a and a second state cycle 400b running for the second logical interface 123b. In some implementations, the state cycle 400 may be performed for only the logical interfaces (for example, for Layer0) and in some implementations, the state cycle may be performed for only the physical interfaces. In some implementations, the state cycle may be performed for both logical and physical interfaces.

In the illustrated implementation, there are three states in the exemplary state cycle 400: discovery state 410, holding state 412, and blackout state 414. Once an acknowledgment message (positive or negative) or a notify message is received from the neighbor node 20a in step 420, the local node 19a transitions from the blackout state 414 to the discovery state 410 in step 422. When the local node 19a enters the discovery state 410, any information currently stored regarding a neighbor node may be flushed out or deleted. Local node 19a then may exchange discover messages and acknowledgment messages with the neighbor node 20a. Local node 19a may be programmed to remain in the discovery state 410 until either: (1) a predetermined number of positive acknowledgment messages are received from the neighbor node 20a (which may be referred to as E_Discovery_Complete) at which time the local node 19a transitions to the holding state 412 in step 424; or until (2) if no acknowledgment message is received from the neighbor node 20a for consecutive discover messages over a predetermined time period (which may be referred to as a discovery-timeout period), the local node 19a transitions to the blackout state 414 in step 426.

In some embodiments, the predetermined number of positive acknowledgement messages may be two (2). In other words, in order to determine E_Discovery_Complete, a two-way association between the local node 19a and the neighbor node 20a is established, meaning that information about the neighbor node 20a is received and confirmed, then two discovery cycles each with positive acknowledgement messages confirming the discovery messages are received by the local node 19a, then the local node 19a transitions to the holding state 412 in step 424.

The discovery-timeout period may be determined by the network administrator. In some embodiments, the discovery-timeout period may be between 100 seconds and 1800 seconds. In one embodiment, the discovery-timeout period may be 300 seconds. In some embodiments, the discovery-timeout period may be X times the discovery-cycle time. In one embodiment, the discovery-timeout period may be 10× the discovery-cycle time, for instance.

During the holding state 412, information about the neighbor node 20a discovered during the discovery state 410 may be periodically checked to ensure that the connection between the local node 19a and the neighbor node 20a is intact. For instance, during holding state 412, the local node 19a may be programmed to periodically send a discover message to the neighbor node 20a. If the neighbor node 20a returns a positive acknowledgment message, the local node 19a remains in the holding state 412. If the neighbor node 20a returns a negative acknowledgment message, the local node 19a transitions back to discovery state 410 in step 428. If no acknowledgment message is received from the neighbor node 20a for the discovery-timeout period, the local node 19a may transition to the blackout state 414 in step 430. In some embodiments, the local node 19a may be programmed to wait until a predetermined number of discover messages have not received any acknowledgment message from the neighbor node 20 before entering blackout state 414.

When no acknowledgment message is received from the neighbor node 20a for an entire discovery-timeout period (in either discovery state 410 or holding state 412), the local node 19a transitions to the blackout state 414 (step 426 or step 430, respectively). Once an acknowledgment message is received from the neighbor node 20a, the local node 19a transitions from the blackout state 414 to the discover state 410 in step 422.

In addition, if the control channel between the local node 19a and the neighbor node 20a becomes faulted, the local node 19a transitions to the blackout state 414 from the discovery state 412 in step 426 or from the holding state in step 430. Transition from the blackout state 414, in such an instance, requires the control channel to be fault free in addition to the other conditions described above (i.e., receipt of a message from the neighbor node 20a).

Referring now to FIGS. 9A and 9B, shown therein is an exemplary workflow diagram illustrating an exemplary discover message exchange cycle 500 between OMS network elements 19 such as first optical node 19a and second optical node 19b over the first OTS 23a and second OTS 23b. Discover message exchange cycle 500 is similar to discover message exchange cycle 300 discussed above. Therefore, in the interest of brevity, only the differences will be described herein in detail. However, the description of the content of the discover messages and acknowledgment messages are expressly incorporated herein by reference in their entirety.

The first optical node 19a may be provided having a first logical interface 123a and a second logical interface 123b, the first optical amplifier 20a may be provided having a first logical interface 221a, a second logical interface 221b, a third logical interface 223a, and a fourth logical interface 223b, and the second optical node 19b may be provided with a first logical interface 125a and a second logical interface 125b.

The discover and acknowledgment messages pertaining to OTS and OMS interfaces (OTS messages/OMS messages) are sent and/or received over associated control channels.

In step 502, the first optical node 19a may generate and send a first discover message intended for the second optical node 19b. In other words, second optical node 19b is a neighbor of first optical node 19a over the OMS 21. The first discover message may be referred to as an OMS discover message because it is intended for the neighbor (second optical node 19b) of first optical node 19a over the OMS 21. The first discover message is sent using OSC 120 and is transmitted over the OSC 120 on behalf of the first logical interface 123a of first optical node 19a and the first logical interface 221a of the optical amplifier 20a across first OTS 23a. The first discover message may include nodal information of the local node (i.e., the first optical node 19a) and, optionally, local node opaque information, which may be application specific. Contents of the local node opaque information are transparent to the SNDP Protocol, and may be embedded within the nodal information. In other words, the optical amplifier 20a does not process the contents of the first discover message.

The first discover message may further include an OMS forwarding function that enables express forwarding of the first discover message at the optical amplifier 20a. In other words, the first logical interface 221a and the third logical interface 223a act as pass-through interfaces and the first discover message does not terminate at the first logical interface 221a or the third logical interface 223a. Further, OMS interface mapping (for instance, AEnd and Zend attributes as illustrated in FIG. 19) may be used to forward SNDP messages such as the first discover message arriving on one OMS interface such as the first logical interface 221a to a next OMS interface such as the third logical interface 223a.

In step 504 the optical amplifier 20a transmits the first discover message from the OSC 214 on behalf of the third logical interface 223a over second OTS 23b to the first logical interface 125a of the second optical node 19b.

After receiving the first discover message, the second optical node 19b correlates the first discover message and generates a first acknowledgment message, which may be positive or negative. A positive acknowledgment message indicates that correlation of the first discover message at the second optical node 19b was successful. A negative acknowledgment message indicates that correlation of the first discover message at the second optical node 19b was not successful. The first acknowledgment message (positive or negative) must reflect the message-ID of the first discover message sent by the first optical node 19a.

In step 506, the second optical node 19b transmits the first acknowledgment message in an “west” direction from the OSC 120b on behalf of the first logical interface 125a to the third logical interface 223a of the optical amplifier 20a.

In step 508, the optical amplifier 20a transmits the first acknowledgment message from the OSC 214 on behalf of the first logical interface 221a over the first OTS 23a to the first logical interface 123a of the first optical node 19a. The first acknowledgment message is processed by the first optical node 19a as described herein.

In step 510, the first optical node 19a may generate and send a second discover message intended for the first optical amplifier 20a over the first OTS 23a. The second discover message may be referred to as an OTS discover message because it is intended for the neighbor of the first optical node 19a over the first OTS 23a. The second discover message may be sent from the OSC 120 on behalf of the second logical interface 123b over the first OTS 23a to the second logical interface 221b of the first optical amplifier 20a.

After receiving the second discover message, the first optical amplifier 20a correlates the second discover message and generates a second acknowledgment message, which may be positive or negative. A positive acknowledgment message indicates that correlation of the second discover message at the first optical amplifier 20a was successful. A negative acknowledgment message indicates that correlation of the second discover message at the first optical amplifier 20a was not successful. The second acknowledgment message (positive or negative) must reflect the message-ID of the second discover message sent by the first optical node 19a.

In step 512, the first optical amplifier 20a transmits the second acknowledgment message in the “west” direction from the OSC 214 on behalf of the second logical interface 221b of the first optical amplifier 20a over the first OTS 23a to the first logical interface 123a of the first optical node 19a. The second acknowledgment message may be processed by the first optical node 19a as described herein.

In step 514, the first optical amplifier 20a may generate and send a third discover message intended for the second optical node 19b over the second OTS 23b. The third discover message may be referred to as an OTS discover message because it is intended for the neighbor of the first optical amplifier 20a over the second OTS 23b. The third discover message may be sent from the OSC 214 on behalf of the fourth logical interface 223b over the second OTS 23b to the second logical interface 125b of the second optical node 19b. To clarify, the steps of the OTS messages are presented in order herein for the purposes of illustration only and step 514 is independent of step 510. In other words, step 514 does not necessarily follow step 512 chronologically.

After receiving the third discover message, the second optical node 19b correlates the third discover message and generates a third acknowledgment message, which may be positive or negative. A positive acknowledgment message indicates that correlation of the third discover message at the second optical node 19b was successful. A negative acknowledgment message indicates that correlation of the third discover message at the second optical node 19b was not successful. The third acknowledgment message (positive or negative) must reflect the message-ID of the third discover message sent by the first optical amplifier 20a.

In step 516, the second optical node 19b transmits the third acknowledgment message in the “west” direction from the OSC 120b on behalf of the second logical interface 125b of the second optical node 19b over the second OTS 23b to the fourth logical interface 223b of the first optical amplifier 20a. The third acknowledgment message may be processed by the first optical amplifier 20a as described herein.

In step 518, the second optical node 19b may generate and send a fourth discover message intended for the first optical node 19a. In other words, in the “west” direction, the first optical node 19a is a neighbor of second optical node 19b over the OMS 21. The fourth discover message may be referred to as an OMS discover message because it is intended for the neighbor (first optical node 19a) of second optical node 19b over the OMS 21. The fourth discover message is sent using OSC 120b and is transmitted over the OSC 120b on behalf of the first logical interface 125a of second optical node 19b and the third logical interface 223a of the first optical amplifier 20a across second OTS 23b. The fourth discover message may include nodal information of the local node (i.e., second optical node 19b) and, optionally, local node opaque information, which may be application specific. Contents of the local node opaque information are transparent to the SNDP Protocol, and may be embedded within the nodal information. In other words, the first optical amplifier 20a does not process the contents of the fourth discover message.

The fourth discover message may further include an OMS forwarding function that enables express forwarding of the fourth discover message at the first optical amplifier 20a. In other words, the first logical interface 221a and the third logical interface 223a act as pass-through interfaces and the fourth discover message does not terminate at the first logical interface 221a or the third logical interface 223a. Further, OMS interface mapping (FIG. 19) may be used to forward SNDP messages such as the fourth discover message arriving on one OMS interface such as the third logical interface 223a to a next OMS interface such as the first logical interface 221a.

In step 520 the first optical amplifier 20a transmits the fourth discover message from the OSC 214 on behalf of the first logical interface 221a over first OTS 23a to the first logical interface 123a of the first optical node 19a.

After receiving the fourth discover message, the first optical node 19a correlates the fourth discover message and generates a fourth acknowledgment message, which may be positive or negative. A positive acknowledgment message indicates that correlation of the fourth discover message at the first optical node 19a was successful. A negative acknowledgment message indicates that correlation of the fourth discover message at the first optical node 19a was not successful. The fourth acknowledgment message (positive or negative) must reflect the message-ID of the fourth discover message sent by the second optical node 19b.

In step 522, the first optical node 19a transmits the fourth acknowledgment message in an “east” direction from the OSC 120a on behalf of the first logical interface 123a to the first logical interface 221a of the first optical amplifier 20a.

In step 523, the first optical amplifier 20a transmits the fourth acknowledgment message from the OSC 214 on behalf of the third logical interface 223a over the second OTS 23b to the first logical interface 125a of the second optical node 19b. The fourth acknowledgment message is processed by the second optical node 19b as described herein.

In step 524, the second optical node 19b may generate and send a fifth discover message intended for the first optical amplifier 20a over the second OTS 23b. The fifth discover message may be referred to as an OTS discover message because it is intended for the neighbor of the second optical node 19b over the second OTS 23b. The fifth discover message may be sent from the OSC 120b on behalf of the second logical interface 125b over the second OTS 23b to the fourth logical interface 223b of the first optical amplifier 20a.

After receiving the fifth discover message, the first optical amplifier 20a correlates the fifth discover message and generates a fifth acknowledgment message, which may be positive or negative. A positive acknowledgment message indicates that correlation of the fifth discover message at the first optical amplifier 20a was successful. A negative acknowledgment message indicates that correlation of the fifth discover message at the first optical amplifier 20a was not successful. The fifth acknowledgment message (positive or negative) must reflect the message-ID of the fifth discover message sent by the second optical node 19b.

In step 526, the first optical amplifier 20a transmits the fifth acknowledgment message in the “east” direction from the OSC 214 on behalf of the fourth logical interface 223b of the first optical amplifier 20a over the second OTS 23b to the second logical interface 125b of the second optical node 19b. The fifth acknowledgment message may be processed by the second optical node 19b as described herein.

In step 528, the first optical amplifier 20a may generate and send a sixth discover message intended for the first optical node 19a over the first OTS 23a. The sixth discover message may be referred to as an OTS discover message because it is intended for the neighbor of the first optical amplifier 20a over the first OTS 23a. The sixth discover message may be sent from the OSC 214 on behalf of the second logical interface 221b over the first OTS 23a to the second logical interface 123b of the first optical node 19a.

After receiving the sixth discover message, the first optical node 19a correlates the sixth discover message and generates a sixth acknowledgment message, which may be positive or negative. A positive acknowledgment message indicates that correlation of the sixth discover message at the first optical node 19a was successful. A negative acknowledgment message indicates that correlation of the sixth discover message at the first optical node 19a was not successful. The sixth acknowledgment message (positive or negative) must reflect the message-ID of the sixth discover message sent by the first optical amplifier 20a.

In step 530, the first optical node 19a transmits the sixth acknowledgment message in the “east” direction from the OSC 120a on behalf of the second logical interface 123b of the first optical node 19a over the first OTS 23a to the second logical interface 221b of the first optical amplifier 20a. The sixth acknowledgment message may be processed by the first optical amplifier 20a as described herein.

While the discover message cycle 500 has been illustrated and described with OMS discover messages being transmitted between three logical interfaces 123a, 221a, 223a, and 125a, and OTS messages being transmitted between three logical interfaces 123b, 221b, 223b, and 125b, the system 10 may be provided having any number of logical interfaces configured to transmit and/or receive OMS discover messages and/or OTS messages for as many OMS links or bands and OTS links as are present on the network 22 (e.g., OMS-C Link, an OMS-L Link, etc.).

This exemplary discover message exchange cycle 500 between network elements such as the first optical node 19a, the first optical amplifier 20a, and the second optical node 19b may continue for n number of cycles or until a state of one or all of the first optical node 19a, the first optical amplifier 20a, and/or the second optical node 19b changes as described herein.

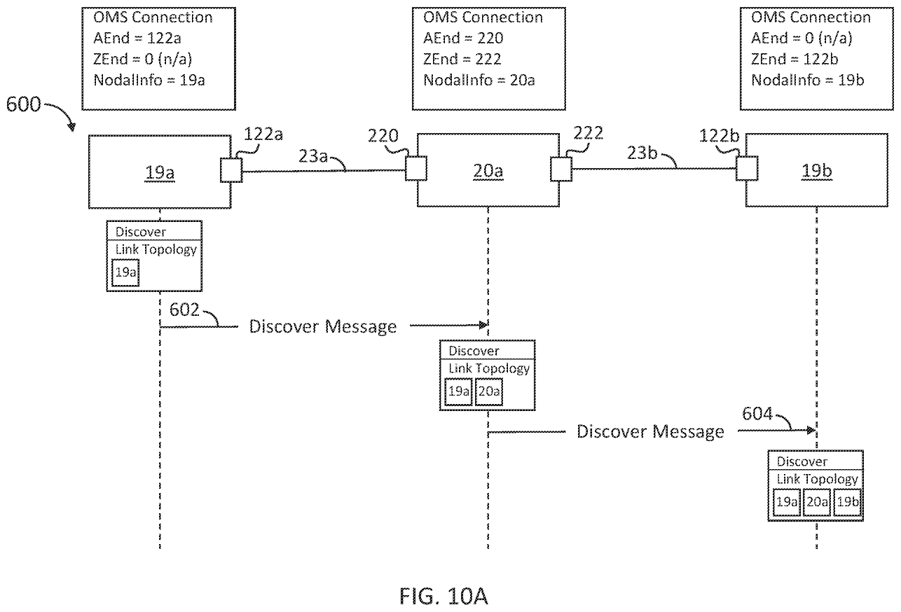

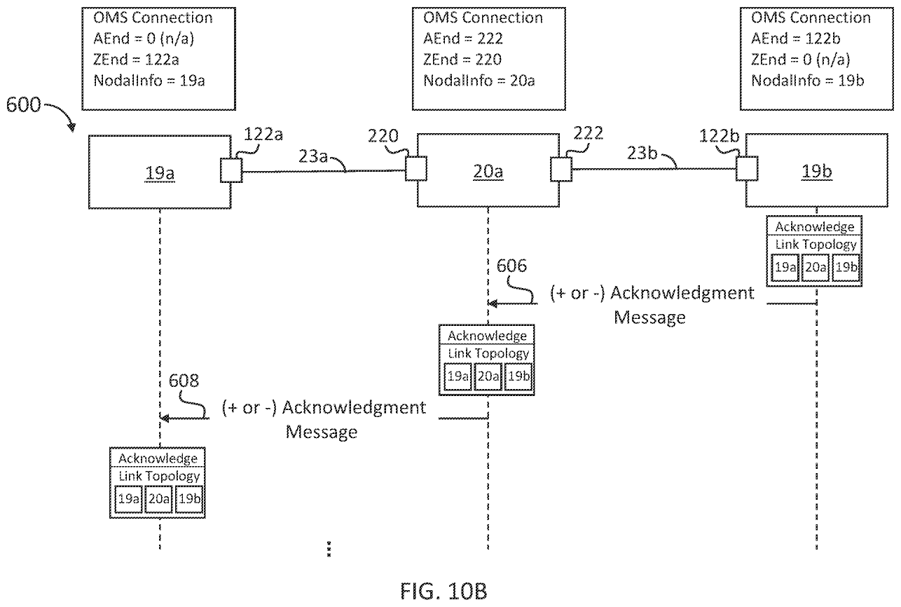

Referring now to FIGS. 10A and 10B, shown therein is an is an exemplary workflow diagram illustrating an exemplary discover message exchange cycle 600 that includes link topology discovery between OMS 21 network elements such as first optical node 19a and second optical node 19b over the first OTS 23a and second OTS 23b. Discover message exchange cycle 600 is similar to discover message exchange cycles 300 and 500 discussed above. Therefore, in the interest of brevity, only the differences will be described herein in detail. However, the description of the content of the discover messages and acknowledgment messages discussed above are expressly incorporated herein by reference in their entirety.

The first optical node 19a may generate a discover message intended for the second optical node 19b. In other words, the second optical node 19b is a neighbor of the first optical node 19a over the OMS 21. The discover message may include link topology info that includes nodal info appended to the discover message at each network element. For instance, upon generation of the discover message, the first optical node 19a appends nodal info (19a is used for illustration purposes) to the discover message in the link topology info.

In step 602, the discover message is sent using the OSC 120 and must first be transmitted between the interface 122a of the first optical node 19a and the first interface 220 of the first optical amplifier 20a across the first OTS 23a. The discover message may further include nodal information of the local node (i.e., the first optical node 19a), and, optionally, local node opaque information which may be application specific. Contents of the local node opaque information are transparent to the SNDP Protocol. In other words, the optical amplifier 20a does not process the contents of the discover message.

After appending nodal info of the optical amplifier 20a (20a is used herein for the purposes of illustration) to the link topology info of the discover message, in step 604 the optical amplifier 20a transmits the discover message from the OSC 214 through the second interface 222 and over the second OTS 23b to the interface 122b of the second optical node 19b.

After receiving the discover message, the second optical node 19b appends nodal info of the second optical node 19b (19b is used for the purposes of illustration) to the link topology info of the discover message, correlates the discover message, and generates an acknowledgment message, which may be positive or negative. A positive acknowledgment message indicates that correlation of the discover message at the second optical node 19b was successful. A negative acknowledgment message indicates that correlation of the discover message at the second optical node 19b was not successful. The acknowledgment message (positive or negative) must reflect the message-ID of the discover message sent by the first optical node 19a. The second optical node 19b records the topology information from the link topology info of the discover message in memory 154b, for instance, and reflects the link topology info of the discover message in the acknowledgement message.

In step 606, the second optical node 19b transmits the acknowledgment message (including the link topology information) in a “west” direction from the OSC 120b through interface 122b over the second OTS 23b to the second interface 222 of the optical amplifier 20a. The acknowledgment message includes the link topology info and may include local node opaque information which may be application specific.

The first optical amplifier 20a records the link topology information carried in the acknowledgment message, then in step 608 the first optical amplifier 20a transmits the acknowledgment message from the OSC 214 through the first interface 220 over the first OTS 23a to the interface 122a of the first optical node 19a.

Upon receipt of the acknowledgment, the first optical node 19a records the link topology information, for instance, in the memory 154a.

The discover message exchange cycle 600 is substantially the same for C Bands and L Bands. The link topology discovery described with respect to discover message exchange cycle 600 may happen for both forward and backward directions and may be performed independently for the C Bands and L Bands.

This exemplary discover message exchange cycle 600 between network elements, such as the first optical node 19a and second optical node 19b, may continue for n number of cycles or until a state of one or both of the first optical node 19a and/or the second optical node 19b changes as described herein.

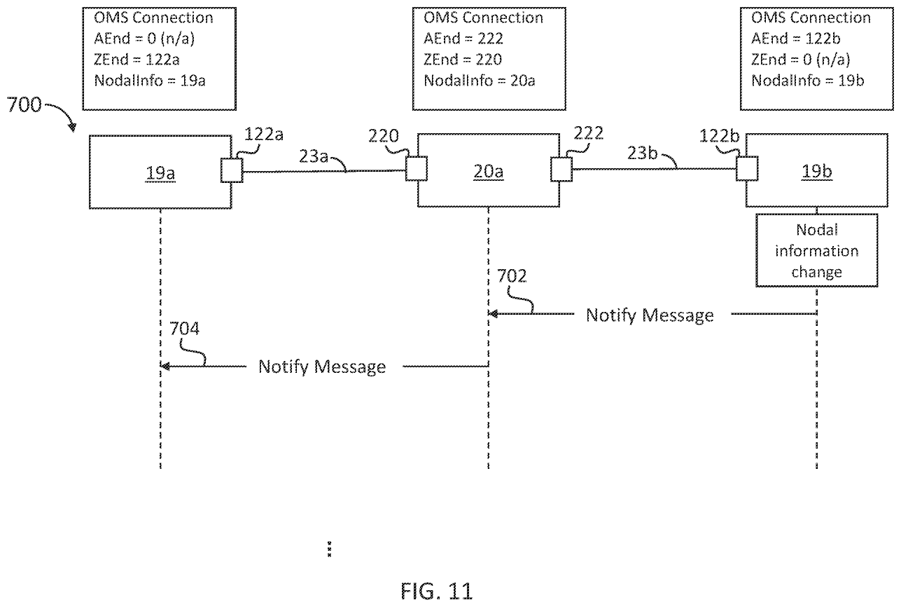

Referring now to FIG. 11, shown therein is an exemplary workflow diagram illustrating an exemplary notify message forwarding cycle 700. If nodal information changes on any network elements downstream (e.g., optical amplifier 20a or optical node 19b) from the head end (e.g., the first optical node 19a), or a new network element is added to the network 22, the network element that changes or is added may be programmed to generate a notify message and send the notify message upstream to the head end. The notify message may include a source node ID (a unique identifier of the sending node) and a notification type (which may include one of an undefined type or a description of the nodal info that changed). The notify message triggers a new discovery-cycle without waiting for the next predetermined time interval for starting the next discovery-cycle. For the purposes of illustration, the second optical node 19b will be described as having a nodal information change and generating the notify message.

After detecting nodal information change(s), the second optical node 19b generates a notify message and transmits the notify message to the first optical node 19a. In step 702, the second optical node 19b transmits a signal containing the notify message from interface 122b across the second OTS 23b to the second interface 222 of the first optical amplifier 20a.

The first optical amplifier 20a (and any other intermediate network elements that may be positioned between the sending node (the second optical node 19b) and the head end (the first optical node 19a)) may be programmed to transparently forward notify messages as described above.

In step 704, the first optical amplifier 20a transmits the notify message from the first interface 220 over the first OTS 23a to the interface 122a of the first optical node 19a. Upon receipt of the notify message, the first optical node 19a may be configured to trigger a discovery cycle with respect to the sending node (the second optical node 19b) or re-evaluate a current state (e.g., blackout, discovery, or holding) immediately instead of waiting for a next discovery-cycle.

In an instance when a new network element is added, the new network element would send a notify message to the head end (e.g., first optical node 19a). Upon receipt of the notify message from the new network element, the first optical node 19a may be configured to trigger a new discovery-cycle associated with the new network element. Existing discovery-cycles may continue unchanged. In other words, the existing discovery-cycles may continue to operate on their predetermined time cycles.

Referring now to FIGS. 12A and 12B, shown therein are diagrammatic representations of a dedicated control-channel model 720 and a shared control-channel model 730. When the dedicated control-channel model 720 is deployed, a simple exchange of node info and interface info is sufficient for use by the SNDP.

When the shared control-channel model 730 is deployed having a plurality of interfaces such as interface 1, interface 2, and interface 3 sharing a single control channel such as OSC 1, a Correlation-ID is used to match the local interface with the remote interface. Correlation-ID may be a simple pre-configured ID (or) a unique Identifier that is sent over TTI or equivalent.

In one implementation of the shared control-channel model 730, discover messages and corresponding acknowledgment messages may be exchanged for each data interface independently. In another implementation of the shared control-channel model 730, an aggregate PDU can be used to group multiple PDUs together in a single message. For example, if there are three data interfaces (interface 1, interface 2, and interface 3) that are bound to the same control channel (OSC 1), discover and/or acknowledgment messages from each of the three data interfaces may be grouped together in an aggregate PDU because they are to be transmitted to the same destination over the same control channel, OSC 1. This improves throughput and messaging performance.

Even though OMS and OTS layer interfaces (e.g., the interface 122) may use the same control channel (e.g., OSC 120) for neighbor discovery, this does not fall under the shared control channel model 730, as the interfaces are associated with or belong to different layers. In other words, for a given layer type, only one interface is bound to the control channel. Hence, correlation-id is not required to be specified for OMS and OTS layer interfaces.

FIG. 13 depicts a hypothetical discover message table 800 illustrating possible information that may be included in a discover message.

FIG. 14 depicts a hypothetical table 850 representing possible information that may be included in a positive acknowledgment message.

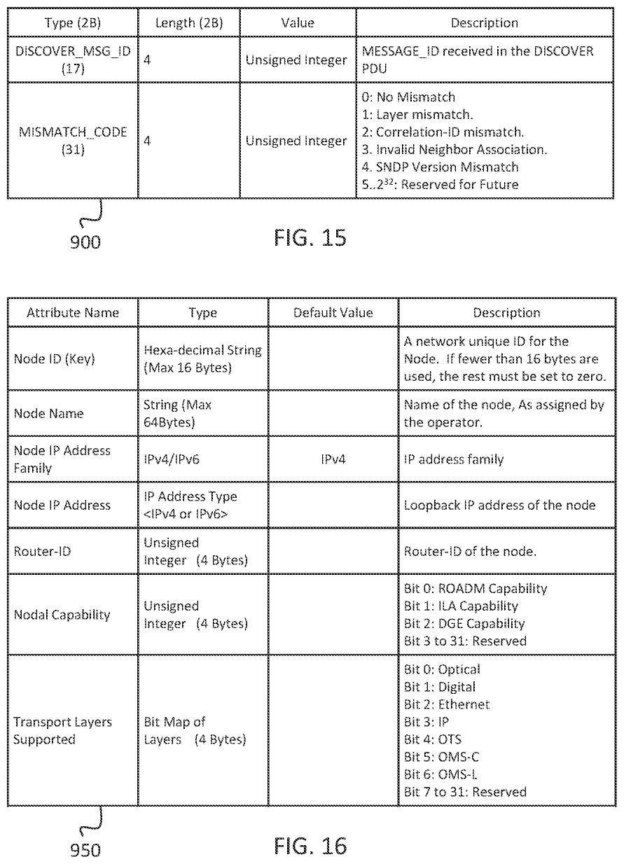

FIG. 15 depicts a hypothetical table 900 representing possible information that may be included in a negative acknowledgment message.

FIG. 16 depicts a hypothetical node information table 950 representing possible node configuration attributes or information that may be included in the SNDP.

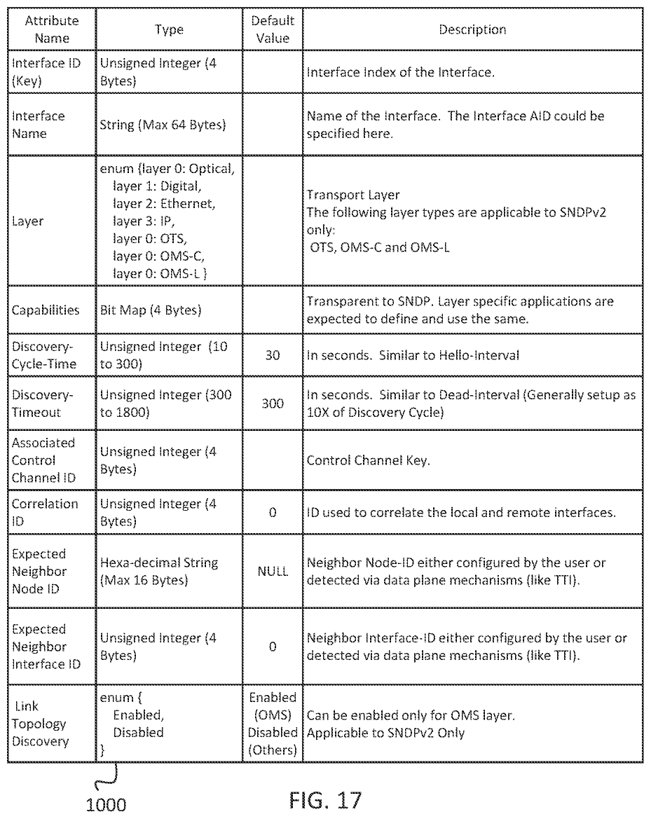

FIG. 17 depicts a hypothetical data interface information table 1000 representing possible interface configuration attributes or information that may be included in the SNDP.

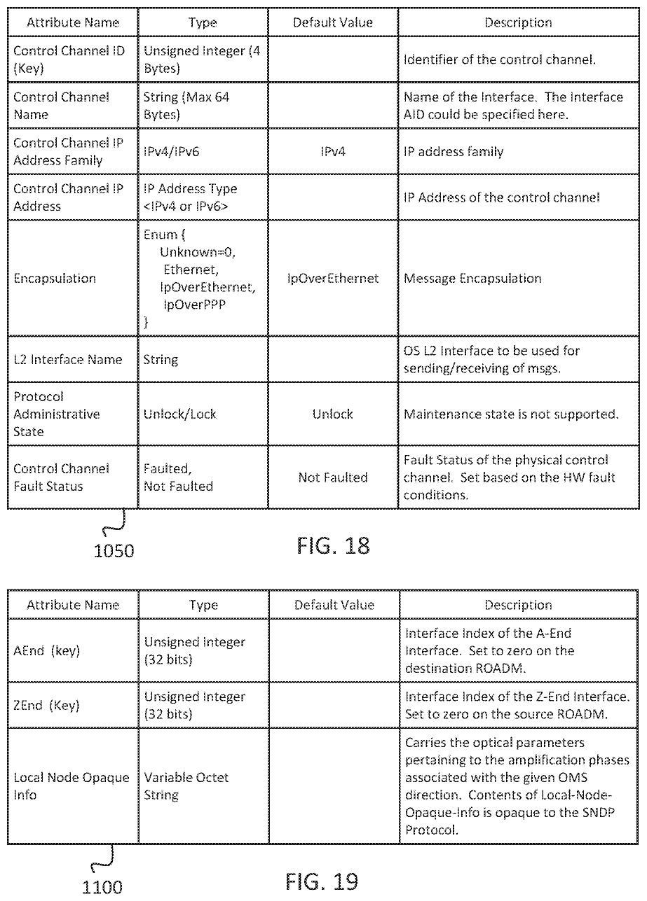

FIG. 18 depicts a hypothetical control channel information table 1050 representing possible control channel configuration attributes or information that may be included in the SNDP.

FIG. 19 depicts a hypothetical OMS Connection information table 1100 representing possible OMS Connection configuration attributes or information that may be included in the SNDP.

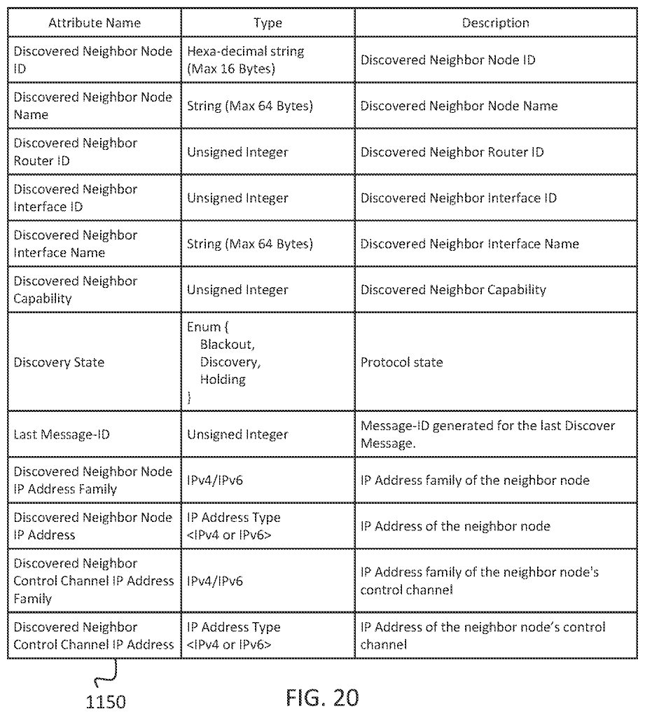

FIG. 20 depicts a hypothetical interface state information table 1150 representing possible attributes or states that may be associated with an interface using the SNDP.

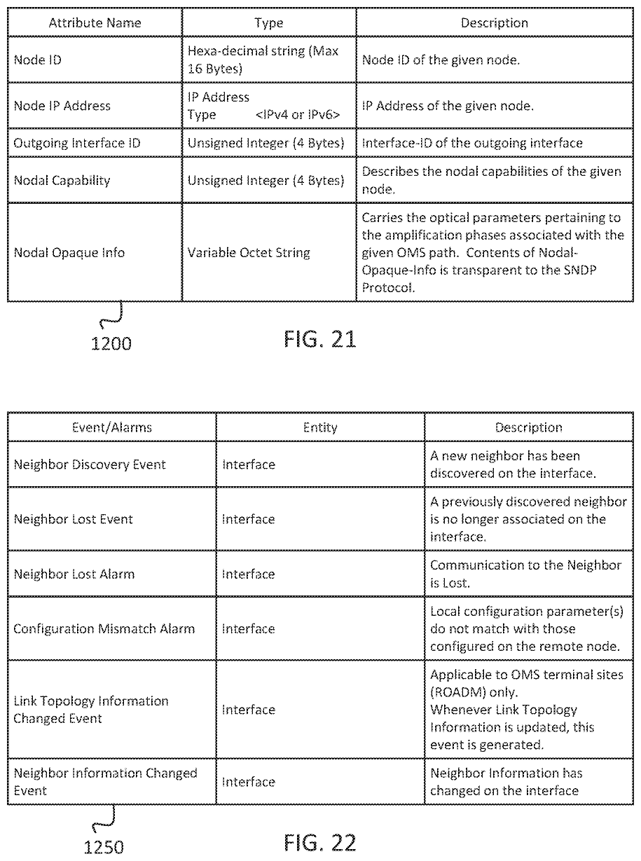

FIG. 21 depicts a hypothetical nodal information state table 1200 representing possible attributes or states that may be associated with a node using the SNDP.

FIG. 22 depicts a hypothetical alarms and events table 1250 representing possible events/alarms used by the SNDP.

Though exemplary tables and messages have been described, it will be understood that more, less, or other tables and messages may be used within the system 10.

Though the above examples have been given in conjunction with Layer0 (e.g., ROADMs, amplifiers), the protocol may be used in any of the layers 0-3. For example, in Layer1 (for example, using TDM switches or multiplexers (a.k.a. muxponders). For example, in Layer2 for ethernet switches. For example, in Layer3 for IP routers.

In some implementations, the layer may be specified as shown in the tables (for example, FIGS. 13, 14, and 17). For example, as shown in FIG. 13, the layer used may be specified such as Layer 0 (Optical, for example OTS, OMS-C, OMS-L), Layer 1 (Digital), Layer 2 (Ethernet), and Layer 3 (IP).

### CONCLUSION

Conventionally, discovery and other network functionality exchange using current protocols cannot be easily adapted for use in all transport layers and the current protocols have inherent assumptions on how protocol data units (PDUs) are encapsulated and exchanged on a network and cannot determine capabilities of neighboring network elements for multiple transport layers. In accordance with the present disclosure, systems and methods are described that provide layer independent discovery of neighbor network elements, the capabilities of those neighbor network elements, a scope of a link between network elements (e.g., whether a link is an optical multiplex section or an optical transmission section), link topology discovery of an optical multiplex section, and neighbor discovery for multiple data ports sharing a common control channel.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

It is to be understood that one or more of the steps disclosed herein may be omitted, one or more steps may be further divided in one or more sub-steps, and two or more steps or sub-steps may be combined in a single step, for example. Further, in some exemplary implementations, one or more steps may be repeated one or more times, whether such repetition is carried out sequentially or interspersed by other steps or sub-steps. Additionally, one or more other steps or sub-steps may be carried out before, after, or between the steps disclosed herein, for example.

Although each dependent claim listed below may directly depend on only one other claim, the disclosure includes each dependent claim in combination with every other claim in the claim set. Further, implementations described herein may be used in combination with one another in whole or in part.

What is claimed is:

1. A network, comprising:
a first network element having a first processor, a first non-transitory computer readable memory storing first instructions, and a first network interface;
a second network element having a second processor, a second non-transitory computer readable memory storing second instructions, and a second network interface; and
a network transmission section connecting the first network element and the second network element;
wherein the first instructions, when executed by the first processor, cause the first processor to generate a discover message and send the discover message from the first network interface over the network transmission section to the second network element, the discover message comprising a message identification, a discovered node ID, and a discovered interface ID;
wherein after receiving the discover message, the second instructions, when executed by the second processor, cause the second processor to generate an acknowledgment message, the acknowledgment message being one of a positive acknowledgment message and a negative acknowledgment message, the positive acknowledgment message indicating that the discovered node ID and the discovered interface ID in the discover message match data identifying the second network element, and the negative acknowledgment message indicating that there was at least one mismatch to the data identifying the discovered node ID and the discovered interface ID in the discover message received by the second network element; and
wherein the second instructions, when executed by the second processor, cause the second processor to send the acknowledgment message from the second network interface over the network transmission section to the first network element.

2. The network of claim 1, wherein the network transmission section further comprises a control channel and the discover message and the acknowledgment message are sent over the control channel.

3. The network of claim 2, wherein the network transmission section is an optical transmission section, the discover message is a first discover message, and the acknowledgment message is a first acknowledgment message, and the first network element further comprises a first logical interface and a second logical interface and the second network element further comprises a third logical interface and a fourth logical interface, the first logical interface and the third logical interface associated with an optical multiplex section of the network formed between the first network element and the second network element, and the second logical interface and the fourth logical interface associated with the optical transmission section;
wherein the first discovery message and the second discovery message are sent over the control channel on behalf of the second logical interface and the fourth logical interface; and
wherein the first instructions, when executed by the first processor, cause the first processor to generate a second discover message and send the second discover message from the first network interface over the control channel on behalf of the first logical interface to the third logical interface of the second network element, the second discover message comprising a message identification, a discovered node ID, and a discovered interface ID;
wherein after receiving the second discover message, the second instructions, when executed by the second processor, cause the second processor to generate a second acknowledgment message, the second acknowledgment message being one of a positive acknowledgment message and a negative acknowledgment message, wherein the positive acknowledgment message indicating that the discovered node ID and the discovered interface ID in the second discover message were matched to identifying data of the second network element, and the negative acknowledgment indicating that there was at least one mismatch to the identifying data of the discovered node ID and the discovered interface ID in the second discover message received by the second network element; and
wherein the second instructions, when executed by the second processor, cause the second processor to send the second acknowledgment message from the second network interface over the control channel on behalf of the third logical interface to the first logical interface of the first network element.

4. The network of claim 1, wherein the first set of instructions cause the first network element to intermittently send the discover message at a predetermined time interval.

5. The network of claim 4, wherein the predetermined time interval is between 10 second and 300 seconds.

6. The network of claim 4, wherein the predetermined time interval is substantially 30 seconds.

7. The network of claim 1, wherein the network further comprises a second network transmission section and a third network element having a third processor, a third non-transitory computer readable memory storing third instructions, a third network interface, and a fourth network interface, the first network transmission section connecting the first network element and the third network element and the second network transmission section connecting the third network element and the second network element to form an optical multiplex section;
wherein the third instructions, when executed by the third processor, cause the third processor to generate a notify message when the third network element is connected to the network, the notify message comprising a source node ID and a notification type and send the notify message from the third interface over the first network transmission section to the first network interface of the first network element; and
wherein, upon receipt of the notify message, the first instructions, when executed by the first processor, cause the first processor to enter a new discovery cycle associated with the third network element.

8. The network of claim 7, wherein entering the new discovery cycle causes the first network element to generate and send a second discover message to the third network element; and
upon receiving the second discover message, the third instructions cause the third network element to generate and send a second acknowledgment message to the first network element.

9. The network of claim 8, wherein the first instructions, when executed by the first processor, cause the first processor to generate and send a third discover message to the second network element, the third discover message configured to be transparently forwarded by the third network element to the second network element; and
upon receiving the third discover message, the second network element generates and sends a third acknowledgment message to the first network element, the third acknowledgment message configured to be transparently forwarded by the third network element to the first network element.

10. The network of claim 7, wherein the third instructions cause the third processor to generate and send a second discover message to the second network element from the fourth network interface over the second network transmission section to the second network element, the second discover message comprising a message identification, a discovered node ID, and a discovered interface ID;
wherein after receiving the second discover message, the second instructions, when executed by the second processor, cause the second processor to generate a second acknowledgment message, the second acknowledgment message being one of a positive acknowledgment message and a negative acknowledgment message, wherein the positive acknowledgment message indicating that the discovered node ID, and the discovered interface ID in the second discover message match identifying data of the second network element, and the negative acknowledgment indicating that there was at least one mismatch to the identifying data of the discovered node ID and the discovered interface ID in the second discover message received by the second network element; and
wherein the second instructions, when executed by the second processor, cause the second processor to send the second acknowledgment message from the second network interface over the second optical transmission section to the third network element.

11. The network of claim 7, wherein the first instructions, when executed by the first processor, cause the first processor to generate and send a second discover message to the second network element, the second discover message comprising a message identification, a discovered node ID, a discovered interface ID, and link topology information including nodal info of the first network element, wherein the second discover message is sent from the first interface of the first network element over the first network transmission section to the third interface of the third network element;
wherein, upon receipt of the second discover message, the third instructions cause the third processor to save the link topology information from the second discover message in the third non-transitory computer readable memory and append nodal info of the third network element to the link topology information and forward the second discover message from the fourth interface to the second interface of the second network element;
wherein, after receiving the second discover message, the second instructions, when executed by the second processor, cause the second processor to save the link topology information from the second discover message in the second non-transitory computer readable memory, append the link topology information with nodal information of the second network element, and generate a second acknowledgment message including the link topology information, the second acknowledgment message being one of a positive acknowledgment message and a negative acknowledgment message, the positive acknowledgment message indicating that the discovered node ID and the discovered interface ID in the second discover message match identifying data of the second network element, and the negative acknowledgment indicating that there was at least one mismatch to the identifying data of the discovered node ID and the discovered interface ID in the second discover message received by the second network element;
wherein the second instructions, when executed by the second processor, cause the second processor to send the second acknowledgment message from the second network interface over the second network transmission section to the fourth network interface of the third network element;
wherein, upon receiving the second acknowledgment message, the third instructions cause the third processor to save the link topology information to the third non-transitory computer readable memory and send the second acknowledgment message from the third network interface over the first optical transmission section to the first network interface of the first network element; and
wherein, upon receiving the second acknowledgment message, the first instructions cause the first processor to save the link topology information in the first non-transitory computer readable medium of the first network element.

12. The network of claim 1, wherein the first network element is a first reconfigurable optical add drop multiplexer and the second network element is a second reconfigurable optical add drop multiplexer.

13. The network of claim 7, wherein the first network element is a reconfigurable optical add drop multiplexer, the second network element is a second reconfigurable optical add drop multiplexer, and the third network element is an optical amplifier.

14. The network of claim 1, wherein the discover message further comprises capability information of the first network element.

15. The network of claim 1, wherein the acknowledgment message further comprises capability information of the second network element.

16. A network element, comprising:
a processor, a network interface connected to a network having a control channel, and a non-transitory computer readable memory storing instructions that, when executed by the processor, cause the network element to:
generate a discover message comprising a message identification, a discovered node ID, and a discovered interface ID;
send a first signal over the control channel of the network to a second network element, the first signal comprising the discover message; and
receive a second signal over the control channel of the network from the second network element, the second signal comprising an acknowledgment message from the second network element, the acknowledgment message being one of a positive acknowledgment message and a negative acknowledgment message; and
wherein receipt of the positive acknowledgment message indicates that the message identification, the discovered node ID, and the discovered interface ID in the discover message match identifying data of the second network element, and receipt of the negative acknowledgment indicates that there was at least one mismatch to the identifying data of the message identification, the discovered node ID, and the discovered interface ID in the discover message received by the second network element.

17. The network element of claim 16, wherein the instructions include a platform adaptation module programmed to configure a protocol of the discover message based on a network layer where the second network element is located as indicated in a layer identification associated with the second network element.

18. The network element of claim 16, wherein the first set of instructions cause the network element to intermittently send the discover message at a predetermined time interval.

19. The network element of claim 18, wherein the predetermined time interval is between 10 second and 300 seconds.

20. The network element of claim 16, wherein the discover message further comprises capability information of the first network element and the acknowledgment message further comprises capability information of the second network element.
